(19) United States
(12) Patent Application Publication
(10) Pub. No.: US 2025/0171719 A1
(43) Pub. Date: May 29, 2025

(54) BIO BASED COMPOSITION

(71) Applicant: Evonik Operations GmbH, Essen (DE)

(72) Inventors: Alexandra Trambitas, Alzenau (DE); Hitesh Vashisht, Bad Homburg (DE); Jochen Kleinen, Heinsberg (DE); Jakob Müller, Haltern am See (DE); Stefan Julian Liebig, Duesseldorf (DE)

(73) Assignee: Evonik Operations GmbH, Essen (DE)

(21) Appl. No.: 18/839,546

(22) PCT Filed: Feb. 20, 2023
(86) PCT No.: PCT/EP2023/054179

§ 371 Date: Aug. 19, 2024

(30) Foreign Application Priority Data
Feb. 24, 2022 (EP) 22158416.2

(51) Int. Cl. C11D 10/04; C11D 1/66; C11D 3/00; C11D 3/386; C11D 9/02; D06L 1/12

(52) U.S. Cl. CPC C11D 10/045; C11D 1/662; C11D 3/0036; C11D 3/38627; C11D 9/02; D06L 1/12

(57) ABSTRACT

A composition of which the main surfactant content is mainly bio based shows a high cleaning capability in the cleaning of textiles or fabrics. Biosurfactants and fatty acid salts further support the cleaning capability for cleaning of fatty stains. A method for cleaning a surface of an article includes combining the composition and the article with water, maintaining a temperature of the water of from 15° C. to 100° C., over a period of from 15 minutes to 240 minutes, while tentatively moving the article in the water, separating the article from the water, and optionally rinsing the article with further water.

### FIELD OF THE INVENTION

The invention relates to a composition, the main surfactant content of which is mainly bio based. The invention also relates to the use of the composition for cleaning, especially of cleaning of textiles or fabrics, preferably for cleaning of fatty stains.

### PRIOR ART

The removal of fatty stains, especially from textiles or fabrics, still is difficult to achieve with detergents, the main surfactants of which are based on renewables, like for example glycolipids. In the state of the art, high amounts of other surfactants, which are not bio based, are included in the compositions to achieve a satisfactory cleansing.

It is an object of the invention to provide a composition with high cleaning capabilities, especially in cleaning of textiles or fabrics, preferably for cleaning of fatty stains.

### DESCRIPTION OF THE INVENTION

It was found that, surprisingly, that compositions, the main surfactant content of which is mainly made up by biosurfactants and fatty acid salts, solve the problem of the instant invention.

The present invention therefore provides a composition comprising
A) at least one biosurfactant, and
B) at least one fatty acid salt,
   as described in more detail in claim 1.

The invention further provides a method of cleaning articles as described in more detail in claim 11.

One advantage of the present invention is that a pure biological detergent is provided with all ingredients being of biological origin by the composition of the instant invention.

Another advantage of the present invention is that detergents with less total surfactant load while maintaining cleaning capabilities are provided by the composition of the instant invention.

A further advantage is that due to the surfactants comprised in the compositions of the instant invention very highly concentrated detergents are provided, which require less total detergent volume during the use, thus enabling for less packaging transport costs and so on.

Another advantage of the present invention is that a detergent with peak performance on fatty stains, especially solid fatty stains is provided.

A further advantage is by the composition of the instant invention a high-performance detergent is provided, which uses less ingredients. Thereby, the formulation complexity is reduced greatly, resulting in a simpler production process.

Another advantage of the present invention is that detergents using mild surfactants with low aqua toxicity are provided by the composition of the instant invention.

The instant invention thus provides a composition comprising
A) at least one biosurfactant, and
B) at least one fatty acid salt,
   characterized in that the ratio of component A) to component B) is in the range of 1:1 to 20:1, preferably 2:1 to 10:1, more preferably 3:1 to 8:1, with the proviso, that component A) and B) account for at least 90 wt.-%, preferably for at least 95 wt.-%, more preferably for at least 98 wt.-%, most preferably for 100 wt.-%, of all surfactants contained in the total composition.

Within the context of the present invention, “biosurfactants” are understood as meaning all glycolipids produced by fermentation. The term “biosurfactant” also covers glycolipids that are chemically or enzymatically modified after fermentation, as long as structurally a glycolipid remains. Raw materials for producing the biosurfactants that can be used are carbohydrates, in particular sugars such as e.g. glucose and/or lipophilic carbon sources such as fats, oils, partial glycerides, fatty acids, fatty alcohols, long-chain saturated or unsaturated hydrocarbons.

In the context of the present invention, the terms “surfactant” is understood to mean organic substances having interface-active properties that have the ability to reduce the surface tension of water at 20° C. and at a concentration of 0.5% by weight based on the overall composition to below 45 mN/m. Surface tension is determined by the DuNoüy ring method at 20° C.

In the context of the present invention, the terms “fatty acid” is understood to mean a carboxylic acid with an aliphatic chain, which might be hydroxy substituted, which is either saturated or unsaturated and comprises from 4 to 32, preferably 6 to 28, carbon atoms.

Where average values are stated hereinbelow, then, unless stated otherwise, these are number-averaged average values.

Unless stated otherwise, percentages are data in percent by weight.

Wherever measurement values are stated hereinbelow, then, unless stated otherwise, these have been determined at a temperature of 25° C. and a pressure of 1013 mbar.

The composition according to the instant invention preferably comprises as component A) at least one biosurfactant selected from rhamnolipids, sophorolipids, glucolipids, cellulose lipids, mannosylerythritol lipids and trehalose lipids, preferably rhamnolipids, sophorolipids and glucolipids, most preferably rhamnolipids. The biosurfactants can be produced e.g. as in EP 0 499 434, U.S. Pat. No. 7,985,722, WO 03/006146, DE 19648439, DE 19600743, JP 01 304034, CN 1337439, JP 2006 274233, JP 2006 083238, JP 2006 070231, WO 03/002700, FR 2740779, DE 2939519, U.S. Pat. No. 7,556,654, FR 2855752, EP 1445302, JP 2008 062179 and JP 2007 181789 or the documents cited therein. Suitable biosurfactants can be acquired e.g. from Soliance, France.

Preferably, the composition according to the instant invention has, as biosurfactant at least one selected from rhamnolipids, in particular mono-, di- or polyrhamnolipids, glucolipids, in particular mono-, di- or polyglucolipids, and sophorolipids, in particular mono-, di- or polysophorolipids, most preferably rhamnolipids.

The term “rhamnolipids” in the context of the present invention preferably is understood to mean particularly compounds of the general formula (I) and salts thereof,

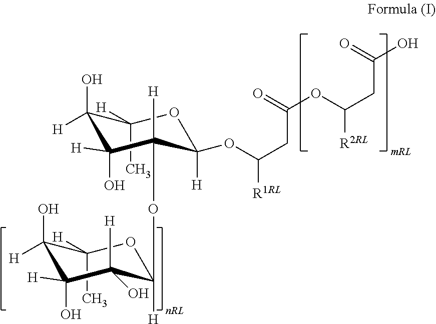

where
mRL=2, 1 or 0,
nRL=1 or 0,
R^{1RL} and R^{2RL}=mutually independently, identical or different, organic residues having 2 to 24, preferably 5 to 13 carbon atoms, in particular optionally branched, optionally substituted, particularly hydroxy-substituted, optionally unsaturated, in particular optionally mono-, bi- or tri-unsaturated alkyl residues, preferably those selected from the group consisting of pentenyl, heptenyl, nonenyl, undecenyl and tridecenyl and (CH₂)ₒ—CH₃ where o=1 to 23, preferably 4 to 12. If nRL=1, the glycosidic bond between the two rhamnose units is preferably in the α-configuration. The optically active carbon atoms of the fatty acids are preferably present as β-enantiomers (e.g. (R)-3-{(R)-3-[2-O—(α-L-rhamnopyranosyl)-α-L-rhamnopyranosyl]oxydecanoyl}oxydecanoate).

The term “di-rhamnolipid” in the context of the present invention is understood to mean compounds of the general formula (I) or salts thereof, where nRL=1.

The term “mono-rhamnolipid” in the context of the present invention is understood to mean compounds of the general formula (I) or salts thereof, where nRL=0.

Distinct rhamnolipids are abbreviated according to the following nomenclature: “diRL-CXCY” are understood to mean di-rhamnolipids of the general formula (I), in which one of the residues R^{1RL} and R^{2RL}=(CH₂)ₒ—CH₃ where o=X-4 and the remaining residue R¹ or R²=(CH₂)ₒ—CH₃ where o=Y-4.

“monoRL-CXCY” are understood to mean mono-rhamnolipids of the general formula (I), in which one of the residues R^{1RL} and R^{2RL}=(CH₂)ₒ—CH₃ where o=X-4 and the remaining residue R^{1RL} or R^{2RL}=(CH₂)ₒ—CH₃ where o=Y-4.

The nomenclature used therefore does not distinguish between “CXCY” and “CYCX”.

For rhamnolipids where mRL=0, monoRL-CX or diRL-CX is used accordingly.

If one of the abovementioned indices X and/or Y is provided with “:Z”, this signifies that the respective residue R^{1RL} and/or R^{2RL} is equal to an unbranched, unsubstituted hydrocarbon residue having X-3 or Y-3 carbon atoms having Z double bonds.

Methods for preparing the relevant rhamnolipids are disclosed, for example, in EP2786743 and EP2787065.

Rhamnolipids applicable in the context of the instant invention can also be produced by fermentation of Pseudomonas, especially Pseudomonas aeruginosa, which are preferably non genetically modified cells, a technology already disclosed in the eighties, as documented e.g. in EP0282942 and DE4127908. Rhamnolipids produced in Pseudomonas aeruginosa cells which have been improved for higher rhamnolipid titres by genetical modification can also be used in the context of the instant invention; such cells have for example been disclosed by Lei et al. in Biotechnol Lett. 2020 June; 42(6):997-1002.

Rhamnolipids produced by Pseudomonas aeruginosa are commercially available from Jeneil Biotech Inc., e.g. under the tradename Zonix, from Logos Technologies (technology acquired by Stepan), e.g. under the tradename NatSurFact, from Biotensidion GmbH, e.g. under the tradename Rhapynal, from AGAE technologies, e.g. under the name R90, R95, R95Md, R95Dd, from Locus Bio-Energy Solutions and from Shanghai Yusheng Industry Co. Ltd., e.g. under the tradename Bio-201 Glycolipids.

The present invention provides a composition preferably comprising as biosurfactant rhamnolipids, characterized in that the biosurfactant component A) comprises
51% by weight to 100% by weight, preferably 60% by weight to 95% by weight, particularly preferably 80% by weight to 90% by weight, of mono-rhamnolipids, especially those of formula (I) with nRL=0,
where the percentages by weight refer to the sum of all of the rhamnolipids present.

This surprisingly elevates the viscosity of the composition according to the instant invention. Preferably this preferred embodiment is combined with a content of soil release agents (see below), preferably of the carboxy methyl inulin type.

The present invention further provides a composition preferably comprising as biosurfactant rhamnolipids, characterized in that the biosurfactant component A) comprises
51% by weight to 95% by weight, preferably 55% by weight to 80% by weight, particularly preferably 60% by weight to 70% by weight, of diRL-C10C10,
where the percentages by weight refer to the sum of all of the rhamnolipids present.

A preferred composition according to the invention is characterized in that the composition comprises as biosurfactant rhamnolipids as described above with a content of
0.5% by weight to 15% by weight, preferably 3% by weight to 12% by weight, particularly preferably 5% by weight to 10% by weight, of diRL-C10C12:1,
where the percentages by weight refer to the sum of all of the rhamnolipids present.

A further preferred composition according to the invention is characterized in that the composition comprises as biosurfactant rhamnolipids as described above with a content of
0.5 to 25% by weight, preferably 3% by weight to 15% by weight, particularly preferably 5% by weight to 12% by weight, of diRL-C10C12,
where the percentages by weight refer to the sum of all of the rhamnolipids present.

A further preferred composition according to the invention is characterized in that the composition comprises as biosurfactant rhamnolipids as described above with a content of
0.1% by weight to 25% by weight, preferably 2% by weight to 10% by weight, particularly preferably 4% by weight to 8% by weight, of diRL-C8C10,
where the percentages by weight refer to the sum total of all rhamnolipids present.

An even further preferred composition according to the invention is characterized in that the composition comprises as biosurfactant rhamnolipids as described above with a content of
0.1% by weight to 5% by weight, preferably 0.5% by weight to 3% by weight, particularly preferably 0.5% by weight to 2% by weight, of monoRL-C8C10 and/or, preferably and
0.1% by weight to 5% by weight, preferably 0.5% by weight to 3% by weight, particularly preferably 0.5% by weight to 2% by weight, of monoRL-C10C10,
where the percentages by weight refer to the sum of all of the rhamnolipids present.

The present invention provides a composition alternatively preferably comprising as biosurfactant rhamnolipids, characterized in that the biosurfactant component A) comprises
10% by weight to 50% by weight, preferably 20% by weight to 40% by weight, particularly preferably 25% by weight to 35% by weight, of monoRL-C10C10 and
where the percentages by weight refer to the sum of all of the rhamnolipids present.

The alternatively preferred composition according to the invention is preferably characterized in that the composition comprises as biosurfactant rhamnolipids as described above with a content of
10% by weight to 30% by weight, preferably 12% by weight to 25% by weight, particularly preferably 15% by weight to 20% by weight, of diRL-C10C10,
where the percentages by weight refer to the sum of all of the rhamnolipids present.

The alternatively preferred composition according to the invention is characterized in that the composition comprises as biosurfactant rhamnolipids as described above with a content of
10% by weight to 30% by weight, preferably 12% by weight to 25% by weight, particularly preferably 15% by weight to 20% by weight, of monoRL-C8C10,
where the percentages by weight refer to the sum of all of the rhamnolipids present.

The alternatively preferred composition according to the invention is characterized in that the composition comprises as biosurfactant rhamnolipids as described above with a content of
3% by weight to 25% by weight, preferably 5% by weight to 20% by weight, particularly preferably 10% by weight to 15% by weight, of monoRL-C10C12:1,
where the percentages by weight refer to the sum total of all rhamnolipids present.

The alternatively preferred composition according to the invention is characterized in that the composition comprises as biosurfactant rhamnolipids as described above with a content of
1% by weight to 15% by weight, preferably 2% by weight to 10% by weight, particularly preferably 3% by weight to 8% by weight, of diRL-C10C12,
where the percentages by weight refer to the sum of all of the rhamnolipids present.

In the context of the present invention, the term “sophorolipids” preferably is understood as meaning compounds of the general formulae (IIa) and (IIb) and salts thereof

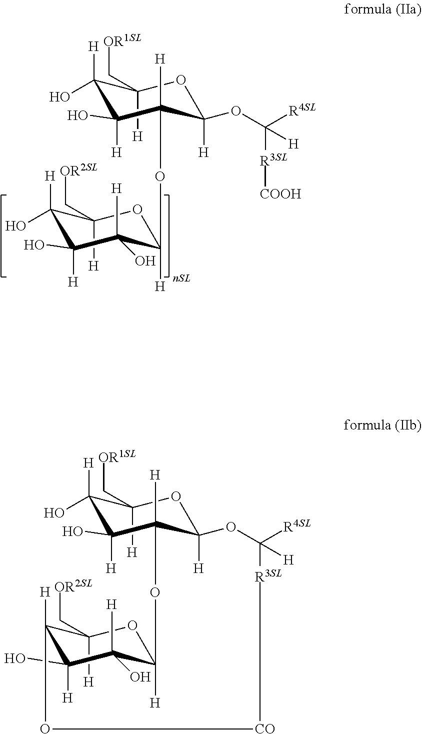

where
R^{1SL}=H or CO—CH₃,
R^{2SL}=H or CO—CH₃,
R^{3SL}=a divalent organic moiety which comprises 6 to 32 carbon atoms and which is unsubstituted or substituted by hydroxyl functions, is unbranched and optionally comprises one to three double or triple bonds,
R^{4SL}=H, CH₃ or a monovalent organic radical which comprises 2 to 10 carbon atoms and which is unsubstituted or substituted by hydroxyl functions, which is unbranched and which optionally comprises one to three double or triple bonds, and
nSL=1 or 0.

Sophorolipids may be used in accordance with the invention in their acid form or their lactone form. Preferred compositions according to the instant invention comprise a sophorolipid in which the ratio by weight of lactone form to acid form is in the range of 20:80 to 80:20, especially preferably in the ranges of 30:70 to 40:60.

To determine the content of sophorolipids in the acid or lactone form in a formulation, refer to EP1411111B1, page 8, paragraph [0053].

In connection with the present invention, the term “glucolipids” preferably is understood as meaning compounds of the general formula (III) and salts thereof,

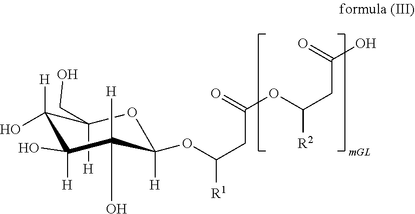

where
mGL=1 or 0,
R^{1GL} and R^{2GL}=independently of one another identical or different organic radical having 2 to 24 carbon atoms, in particular optionally branched, optionally substituted, in particular hydroxy-substituted, optionally unsaturated, in particular optionally mono-, di- or triunsaturated, alkyl radical, preferably one selected from the group consisting of pentenyl, heptenyl, nonenyl, undecenyl and tridecenyl and (CH₂)ₒ—CH₃ where o=1 to 23, preferably 4 to 12.

Distinct glucolipids are abbreviated according to the following nomenclature: “GL-CXCY” is understood as meaning glucolipids of the general formula (III) in which one of the radicals R^{1GL} and R^{2GL}=(CH₂)ₒ—CH₃ where o=X-4 and the remaining radical R^{1GL} or R^{2GL}=(CH₂)ₒ—CH₃ where o=Y-4.

The nomenclature used thus does not differentiate between “CXCY” and “CYCX”.

If one of the aforementioned indices X and/or Y is provided with “:Z”, then this means that the respective radical R^{1GL} and/or R^{2GL}=an unbranched, unsubstituted hydrocarbon radical with X-3 or Y-3 carbon atoms having Z double bonds.

Methods for production of glucolipids can be carried out as described in WO2019154970. The content of glucolipids of formula (III) surprisingly elevates the viscosity of the composition according to the instant invention. Preferably this preferred embodiment is combined with a content of soil release agents (see below), preferably of the carboxy methyl inulin type.

A preferred composition according to the instant invention is characterized in that the fatty acid salt is selected from the group of salts of caprylic acid, capric acid, lauric acid, myristic acid, palmitic acid, stearic acid, ricin oleic acid, oleic acid, linoleic acid, elaidic acid, arachidic acid, palmiloteic acid, erucic acid, arachidic acid, linolenic acid and alpha linoleic acid.

The fatty acids salts comprised in the composition of the instant invention are commonly known as soaps, that are obtainable by e.g. saponification of fats and/or oils. Thus, usually mixtures of different fatty acid salts are comprised in the compositions according to the instant invention. Preferred fatty acid salts comprised in the compositions according to the instant invention thus are mixtures of salts of fatty acids, wherein the fatty acids resemble mixtures of fatty acid distributions present in natural oils or mixtures thereof, preferably selected from the group of palm oil, palm kernel oil, coconut oil, olive oil, bay laurel oil, sunflower oil, acai berry oil, avocado oil, bakuchiol oil, black cumin oil, borage oil, castor oil, cherry kernel oil, evening primrose oil, grapeseed oil, hazelnut oil, jojoba oil, macadamia nut oil, marula oil, neem oil, pomegranate seed oil, soybean oil and raps oil. Other possible oils are tallow, lard or fish oil A further preferred composition according to the instant invention is characterized in that the fatty acid salt comprise a fatty acids salt mixture with a carbon chain distribution:

| | | |
|---|---|---|
| C6:0 | 0-1 | wt.-% |
| C8:0 | 7-8 | wt.-% |
| C10:0 | 5-8 | wt.-% |
| C12:0 | 47-52 | wt.-% |
| C14:0 | 16-20 | wt.-% |
| C16:0 | 0-9.5 | wt.-%% |
| C18:0 | 0-3 | wt.-% |
| C18:1 | 4-6.5 | wt.-%, |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0 | 0-0.3 | wt.-% |
| C8:0 | 0-0.3 | wt.-% |
| C10:0 | 0-0.5 | wt.-% |
| C12:0 | 50-60 | wt.-% |
| C14:0 | 18-24 | wt.-% |
| C16:0 | 9-14 | wt.-% |
| C18:0 | 7-15 | wt.-% |
| C18:1 | 0-0.5 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0 | 0-2 | wt.-% |
| C8:0 | 57-61 | wt.-% |
| C10:0 | 38-42 | wt.-% |
| C12:0 | 0-3 | wt.-% |
| C14:0 | 0-1 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0 | 0-2 | wt.-% |
| C8:0 | 0-2 | wt.-% |
| C10:0 | 0-2 | wt.-% |
| C12:0 | 51-64 | wt.-% |
| C14:0 | 16-25 | wt.-% |
| C16:0 | 6-12 | wt.-% |
| C18:0 | 6-12 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0 | 0-1 | wt.-% |
| C8:0 | 1-5 | wt.-% |
| C10:0 | 1-5 | wt.-% |
| C12:0 | 45-50 | wt.-% |
| C14:0 | 14-28 | wt.-% |
| C16:0 | 7-10 | wt.-% |
| C18:0 | 1-3 | wt.-% |

| | |
|---|---|
| C18:1 | 12-19 |
| C18:2 | 2-4 |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0-C10:0 | 0-4 | wt.-% |
| C12:0 | 47-54 | wt.-% |
| C14:0 | 15-19 | wt.-% |
| C16:0 | 7-11 | wt.-% |
| C18:0 | 1-3 | wt.-% |
| C18:1 | 14-20 | wt.-% |
| C18:2 | 2-4 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0-C10:0 | 0-4 | wt.-% |
| C12:0 | 47-54 | wt.-% |
| C14:0 | 15-19 | wt.-% |
| C16:0 | 7-11 | wt.-% |
| C18:0 | 16-24 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C6:0-C10:0 | 0-2 | wt.-% |
| C12:0 | 48-58 | wt.-% |
| C14:0 | 14-20 | wt.-% |
| C16:0 | 7-12 | wt.-% |
| C18:0 | 14-24 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C16:0 | 7.5-20 | wt.-% |
| C18:0 | 0.5-5 | wt.-% |
| C18:1 | 55-83 | wt.-% |
| C18:2 | 3.5-21 | wt.-% |
| C18:3 | 0-1.5 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C16:0 | 10-16 | wt.-% |
| C18:0 | 3-5 | wt.-% |
| C18:1 | 23-26 | wt.-% |
| C18:2 | 48-54 | wt.-% |
| C18:3 | 5-8 | wt.-% |

where the percentages by weight refer to the sum total of all fatty acid salts present.

A further preferred composition according to the instant invention is characterized in that the fatty acid salt comprise a fatty acids salt mixture with a carbon chain distribution:

| | | |
|---|---|---|
| C16:0 | 3-4 | wt.-% |
| C18:0 | 1-2 | wt.-% |
| C18:1 | 61-64 | wt.-% |
| C18:2 | 18-22 | wt.-% |
| C18:3 | 9-10 | wt.-% |

where the percentages by weight refer to the sum total of all fatty acid salts present.

A preferred composition according to the instant invention is characterized in that in the fatty acid salt the cations of the salt is selected from the group of Li+, Na+, K+, Mg²⁺, Ca²⁺, Al³⁺, Zn²⁺, NH⁴⁺, primary ammonium ions, secondary ammonium ions, tertiary ammonium ions and quaternary ammonium ions, with Na+ and K+ being preferred, Na+ being most preferred.

A preferred composition according to the instant invention is characterized in that the fatty acid salt is selected from the group of salts of caprylic acid, capric acid, lauric acid, myristic acid, palmitic acid, stearic acid, ricinoleic acid, oleic acid, linoleic acid and linolenic acid.

The fatty acids salts comprised in the composition of the instant invention are commonly known as soaps, that are obtainable by e.g. saponification of fats and or oils. Thus, usually mixtures of different fatty acid salts are comprised in the compositions according to the instant invention. Preferred fatty acid salts comprised in the compositions according to the instant invention thus are mixtures of salts of fatty acids, wherein the fatty acids resemble mixtures of fatty acid distributions present in natural oils or mixtures thereof, preferably selected from the group of palm oil, palm kernel oil, coconut oil, olive oil, bay laurel oil, sunflower oil and raps oil. Other possible oils are tallow, lard or fish oil A preferred composition according to the instant invention is characterized in that in the fatty acid salt the cations of the salt is selected from the group of Li⁺, Na⁺, K⁺, Mg²⁺, Ca²⁺, Al³⁺, Zn2⁺, NH₄⁺, primary ammonium ions, secondary ammonium ions, tertiary ammonium ions and quaternary ammonium ions, with Na⁺ and K⁺ being preferred, Na⁺ being most preferred.

A preferred composition according to the instant invention further comprises
C) at least one builder.

Any builder known in the art for use in laundry detergents may be utilized, these can be for example mineral, polymeric and organic builders.

The builder may particularly be a chelating agent that forms water-soluble complexes with calcium and magnesium. Non-limiting examples of builders include zeolites, diphosphates (pyrophosphates), triphosphates such as sodium triphosphate (STP or STPP), phosphonates carbonates such as sodium carbonate, soluble silicates such as sodium metasilicate, layered silicates (e.g., SKS-6 from WeylChem Lamotte S.A.S), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof. homopolymers of polyacrylates or copolymers thereof, such as poly(acrylic acid) (PAA) or copoly(acrylic acid/maleic acid) (PAA/PMA). Further non-limiting examples include polycarboxylic acid that can be used in the form of free acid and/or of the salts thereof, wherein polycarboxylic acids shall be understood to mean those carboxylic acids that carry more than one acid function. These includes for example, citric acid, adipic acid, succinic acid, glutaric acid malic acid, tartric acid, maleic acid, fumaric acid, saccharic acid, ascorbic acid, itaconic acid. Aminocarboxylates, and aminopolycarboxylates, carboxymethyl inulin, carboxymethyl cellulose and/or the salts thereof are another significant class of phosphate-free buildners. Particularly preferred representatives of this class are glutamic acid-N,N-diacetic acid (GLDA) and methylglycine N,N-diacetic acid. (MGDA). Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), glutamic acid-N,N-diacetic acid (GLDA), 1-hydroxyethane-1,1-diphosphonic acid (HEDP), ethylenediaminetetra-(methylenephosphonic acid) (EDTMPA), diethylenetriaminepentakis(methylenephosphonic acid) (DTPMPA or DTMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)-ethylidenediamine-N,N′,N′-triacetate (HEDTA), diethanolglycine (DEG), diethylenetriamine penta(methylenephosphonic acid) (DTPMP), aminotris(methylenephosphonic acid) (ATMP), and combinations and salts thereof.

Preferred builders comprised in the composition according to the instant invention are selected from the group of aminopolycarboxylates, like N,N-dicarboxymethyl glutamic acid and methylglycine N,N-diacetic acid, citrates, polyitaconic acid, polyaspartic acids and polyglutamic acids, aspartic acid, glutamin acid, carboxymethyl inulin, carboxy methyl cellulose and combinations and salts thereof

A preferred composition according to the instant invention further comprises
D) at least one enzyme.

Enzymes are useful additives in laundry compositions. The enzymes preferably comprised in the composition according to the instant invention are selected from the group consisting of protease, amylase, lipase, pectinase, cellulase, phosphodiesterase, mannanase, cutinase, pectate lyase, peroxidase, oxidase and laccase with protease, amylase, lipase, pectinase, cellulase, phosphodiesterase and mannanase being especially preferred.

The enzymes to be used in the context of the present invention can, for example, originally originate from microorganisms, for example of the genera Bacillus, Streptomyces, Humicola, or Pseudomonas, and/or be produced by suitable microorganisms according to known biotechnological processes, for example by transgenic expression hosts, for example of the genera Escherichia, Bacillus, or filamentous fungi.

It is emphasized that it can in particular also be technical enzyme preparations of the respective enzyme, i.e. accompanying substances may be present. The enzymes can therefore be packaged and used together with accompanying substances, for example from fermentation or with other stabilizers.

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metaloproteases protease may for example be a thermolysin from e.g. family M4 or other metalloprotease such as those from M5, M7 or M8 families.

Examples of proteases are the subtilisins BPN from Bacillus amyloliquefaciens and Carlsberg from Bacillus licheniformis, the protease PB92, the subtilisins 147 and 309, the protease from Bacillus lentus, subtilisin DY and the subtilases, but no longer assigned to the subtilisins in the narrower sense Thermitase, Proteinase K and the proteases TW3 and TW7.

Subtilisin Carlsberg is in a further developed form under the trade name Alcalase® from the Novozymes A/S, Bagsvasrd, Denmark.

The subtilisins 147 and 309 are sold by the Novozymes company under the trade names Esperase® and Savinase®, respectively. The protease variants under the name BLAP® are derived from the protease from Bacillus lentus DSM 5483. Further usable proteases are, for example, those under the trade names Durazym®, Relase®, Everlase®, Nafizym®, Natalase®, Kannase® and Ovozyme® from Novozymes, which are among trade names, Purafect®, Purafect® OxP, Purafect® Prime, Excellase® and Properase® from the company Danisco/Genencor, which operates under the trade name Protosol® from Company Advanced Biochemicals Ltd., Thane, India, which operates under the trade name Wuxi® from the company Wuxi Snyder Bioproducts Ltd., China, which operates under the trade name Proleather® and Protease P® from Amano Pharmaceuticals Ltd., Nagoya, Japan, and the enzyme available under the name Proteinase K-16 from Kao Corp., Tokyo, Japan.

The proteases from Bacillus gibsonii and Bacillus pumilus, which are disclosed in the international patent applications WO 08/086916 and WO 07/131656, are also particularly preferably used. Further advantageously usable proteases are disclosed in the patent applications WO 91/02792, WO 08/007319, WO 93/18140, WO 01/44452, GB 1243784, WO 96/34946, WO 02/029024 and WO 03/057246. Other proteases that can be used are those found in the microorganisms Stenotrophomonas maltophilia, in particular Stenotrophomonas maltophilia K279a, Bacillus intermedius and Bacillus sphaericus are naturally present.

Other commercially available proteases are: Liquanase® EC 3.5 L, Liquanase® Evity® EC 3.5 L, Liquanase® 3.5 L, Liquanase® Evity®3.5 L, Preferenz P100, Preferenz P200, Preferenz P300, Biotouch ROC, BIOPROTEASA L 800 ST, Bioproteasa 800 P, Bioproteasa L 800, Lavergy® Pro 114 LS, Progress Uno EC 100 L, Progress Uno 100 L, Progress Uno 101 L, EFFECTENZ™ P 100 (A01339), EFFECTENZ™ P 150, Savinase® Evity® EC 16 L, Savinase® Evity® EC 24 T, Savinase® Evity® 16 L, Savinase® Evity® 24 T, Excellenz P 1250, Blaze® Evity® EC 150 T, Blaze® Evity®150 T, Blaze® Evity®125 T, Blaze Evity 16 L, Excellase, Purafect, Purafect OxP, Purafect Prime, Properase, Blaze® Pro EC 100 L, Blaze® Pro 100 L, Blaze Exceed 100 T, Progress Key 150 T, Progress Excel 101 L.

A protease preferably comprised in the composition according to the instant invention is Liquanase® 2.5 L.

Suitable amylases which can be used herein may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Examples of amylases are the α-amylases from Bacillus licheniformis, from Bacillus amyloliquefaciens or from Bacillus stearothermophilus and, in particular, their improved further developments for use in detergents or cleaning agents.

The enzyme from Bacillus licheniformis is available from the Novozymes company under the name Termamyl® and from the Danisco/Genencor company under the name Purastar® ST.

Further development products of this α-amylase are available from Novozymes under the trade names Duramyl® and Termamyl® ultra, from Danisco/Genencor under the name Purastar®OxAm and from Daiwa Seiko Inc., Tokyo, Japan, as Keistase®.

The α-amylase from Bacillus amyloliquefaciens is sold by the Novozymes company under the name BAN®, and variants derived from the α-amylase from Bacillus stearothermophilus under the names BSG® and Novamyl®, also from the Novozymes company.

Furthermore, the α-amylase from Bacillus sp.

A 7-7 (DSM 12368) and the cyclodextrin glucanotransferase (CGTase) from Bacillus agaradherens (DSM 9948) should be emphasized.

The amylolytic enzymes disclosed in the international patent applications WO 03/002711, WO 03/054177 and WO07/079938 can also be used.

Fusion products of all the molecules mentioned can also be used. In addition, the further developments of the α-amylase from Aspergillus niger and A. oryzae available from the Novozymes company under the trade names Fungamyl® are suitable. Further commercial products that can be used advantageously are, for example, the Amylase-LT® and Stainzyme® or Stainzyme Ultra® or Stainzyme Plus®, the latter also from Novozymes. Variants of these enzymes obtainable by point mutations can also be used according to the invention.

Other commercially available amylases are: Amplify Prime EC 110 L, Amplify Prime 100 L, PREFERENZ S 110, Bioamyl P, Stainzyme Plus Evity, Stainzyme® Plus Evity® EC 12 T, Stainzyme® Plus Evity® EC 24 T, Stainzyme® Plus Evity®24 T, EFFECTENZ™ S 100, EFFECTENZ™ S210, Bialfa T, Achieve Alpha EC 110 L, Achieve Alpha 100 L, Achieve® Advance 150 T, Stainzyme, Amplify, Duramyl, Novamyl, Amplify™ Prime 100 L is preferably comprised in the composition according to the instant invention Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Examples of cellulases (endoglucanases, EG) is the fungal, endoglucanase (EG)-rich cellulase preparation or its further developments, which is offered by the Novozymes company under the trade name Celluzyme®.

The products Endolase® and Carezyme®, also available from Novozymes, are based on the 50 kD-EG, or the 43 kD-EG from Humicola insolens DSM 1800. Other commercial products from this company that can be used are Cellusoft®, Renozyme® and Celluclean®. Cellulases, for example, which are available from the company AB Enzymes, Finland, under the trade names Ecostone® and Biotouch®, and which are at least partly based on the 20 kD EG from Melanocarpus, can also be used. Other cellulases from AB Enzymes are Econase® and Ecopulp®. Further suitable cellulases are from Bacillus sp. CBS 670.93 and CBS 669.93, the ones from Bacillus sp. CBS 670.93 from the company Danisco/Genencor is available under the trade name Puradax®. Other commercial products from Danisco/Genencor that can be used are “Genencor detergent cellulase L” and IndiAge®Neutra.

Other commercially available cellulases are: Carezyme® Premium EC 4510 L, Carezyme® Premium Evity® EC 5000 T, Carezyme® Premium 4500 L, Carezyme® Premium Evity® 5000 T, REVILATENZ 200, Biotouch DCL/FCL, Biosoft L Pure, Rocksoft, Retrocell, Retrocell ZircoN, Puradax EG 7000L, Biotouch FCC, BIOCELULASA MC L, BIOCELULASA MC P, Celluclean® EC 5000 L, Celluclean® 5000 L, REVILATENZ 200, Biotouch FLX, Lavergy® C Bright 100 L, Celluclean® Evity® EC 4500 T, Celluclean® Evity® 4500 T, Biotouch DCC,

Further preferred enzymes present in the composition of the instant invention are those known under the term glycosidases (E.C. 3.2.1.X). These include in particular arabinases, fucosidases, Galactosidases, galactanases, arabico-galactan-galactosidases, mannanases (also referred to as mannosidases or mannases), glucuronosidases, agarase, carrageenases, pullulanases, β-glucosidases, xyloglucanases (xylanases), xanthanases and pectin-degrading enzymes. Preferred glycosidases are also summarized under the term hemicellulases. Hemicellulases include in particular mannanases, xyloglucanases (xylanases), β-glucosidases and carrageenases and also pectinases, pullulanases and β-glucanases. Pectinases are pectin-degrading enzymes, the hydrolytic pectin-degrading enzymes in particular belonging to the enzyme classes EC 3.1.1.1 1, EC 3.2.1.15, EC 3.2.1.67 and EC 3.2.1.82. In the context of the present invention, the pectinases also include enzymes with the designations pectin lyase, pectin esterase, pectin demethoxylase, pectin methoxylase, pectin methylesterase, pectase, pectin methylesterase, pectinoesterase, pectin-galle-lactase, pectin-gal-galase, pectin-gal-galase, pectin-gal-galase, pectin-gal-galase, pectin-gal-galase, pectin-gal-galase, pectin-gal-galonase, pectin-galactolase, endopoly-nolase, pectin-poly-galase, pectin-polyhydrolase, pectin-poly-galase, pectin-polyhydrolase, pectin-poly-galase, pectin-poly-galase-a-1, 4-galacturonide glycanohydrolase, endogalacturonase, endo-D-galacturonase, galacturan 1, 4-a-galacturonidase, exopolygalacturonase, poly (galacturonate) hydrolase, exo-D-galacturonase, exo-D-galacturonanase-Galacturonase, exo-poly-a-galacturonosidase, Exopolygalacturonosidase or exopolygalacturanosidase.

Examples of enzymes suitable in this regard are, for example, under the names Gamanase®, Pektinex AR® or Pectaway® from Novozymes, under the name Rohapec® B1 L from AB Enzymes and under the name Pyrolase® from Diversa Corp., San Diego, CA, USA.

The β-glucanase obtained from Bacillus subtilis is available under the name Cereflo® from the Novozymes company.

Glycosidases or hemicellulases which are particularly preferred according to the invention are mannanases, which for example, under the trade name Mannaway® by the Novozymes company or Purabrite® by the Danisco/Genencor company.

Examples of commercially available mannanases are: Mannaway® EC 200 L, Mannaway® EC 108 L, Mannaway®200 L, Mannaway® 100 L, PREFERENZ M100, Biotouch M, Biomananasa 2XL. A mannanase preferably comprised in the composition according to the instant invention is Mannaway®4.0 L.

Examples of commercially available pectate lyases are: Xpect® EC 1000 L, Xpect® EC 1000 T, Xpect®1000 L, Xpect®1000 T, PREVERENZ F 1000, Pectex Pure, Lavergy® Pro 106 L, Lavergy® Pro 106 LS.

Examples of commercially available licheninases are: Lift INTENT 100 L, Lift INTENT 100 T.

Suitable lipases and cutinases include those of bacterial or fungal origin. Chemically modified or protein engineered mutant enzymes are included. Examples of lipases or cutinases are those originally from Humicola lanuginose (Thermomyces lanuginosus) obtainable or further developed therefrom, in particular those with the amino acid substitution D96L. They are sold, for example, by the company Novozymes under the trade names Lipolase®, Lipolase®Ultra, LipoPrime®, Lipozyme® and Lipex®.

Another lipase which can be used advantageously is available from the Novozymes company under the trade name Lipoclean®.

Furthermore, for example, the cutinases that were originally isolated from Fusarium solani pisi and Humicola insolens can be used. Lipases that can also be used are available from Amano under the names Lipase CE®, Lipase P®, Lipase B®, or Lipase CES®, Lipase AKG®, Bacillis sp. Lipase®, Lipase AP®, Lipase M-AP® and Lipase AML® available. For example, the lipases or cutinases from the Danisco/Genencor company can be used whose starting enzymes were originally isolated from Pseudomonas mendocina and Fusarium solanii. Other important commercial products are the preparations M1 Lipase® and Lipomax® originally sold by the company Gist-Brocades (now Danisco/Genencor) and those from the company Meito Sangyo KK, Japan, under the name Lipase MY-30®, Lipase OF® and Lipase PLO, as well as the product Lumafast® from Danisco/Genencor.

Other example of commercially available lipases are: Lipex® Evity® EC 100 L, Lipex® Evity® EC 100 T, Lipex® Evity® EC 200 L, Lipex® Evity®100 L, Lipex® Evity®100 T, Lipex® Evity®200 L, PREFERENZ L 100, Biolipasa 2XL, Biolipasa L, Biolipasa P, Lipoclean, Lipolase, Lipolase Ultra.

A lipase preferably comprised in the composition according to the instant invention is Lipex™ 100 L Evity.

Examples of commercially available Phosphodiesterase are: Pristine from Novozyme Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257.

Commercially available peroxidases include Guardzyme™ (Novozymes A/S).

A preferred composition according to the instant invention is characterized in that it comprises
A) in an amount of from 5.0 wt.-% to 60 wt.-%, preferably from 8.0 wt.-% to 40 wt.-%, more preferably from 10.0 wt.-% to 30 wt.-%,
B) in an amount of from 0.5 wt.-% to 30 wt.-%, preferably from 1.0 wt.-% to 20 wt.-%, more preferably from 1.5 wt.-% to 10 wt.-%, as may be the case
C) in an amount of from 1.0 wt.-% to 30 wt.-%, preferably from 2.0 wt.-% to 20 wt.-%, more preferably from 3.0 wt.-% to 10 wt.-%, and as may be the case
D) in an amount of from 0.2 wt.-% to 10 wt.-%, preferably from 1.0 wt.-% to 8.0 wt.-%, more preferably from 1.5 wt.-% to 6.0 wt.-%,
   where the percentages by weight refer to the total composition.

A preferred composition according to the instant invention is characterized in that it comprises at least one non-biosurfactant, preferably selected from the group of anionic, cationic, non-ionic, semi-polar and zwitterionic surfactants.

It is obvious, that the optionally comprised non-biosurfactant can be comprised at a maximum of 10 wt.-% of all surfactants contained in the total composition.

Preferably the non-biosurfactant is selected from the group of fatty alcohol alkoxylates. These can be advantageously used for cleaning a surface of a textile or a fabric containing polyamines.

Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

Non-limiting examples of non-ionic surfactants include alcohol ethoxylates (AE or AEO), which are preferably comprised in the composition according to the instant invention, alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), polyglycerol esters, glaycerol esters, propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

Non-limiting examples of zwitterionic surfactants include betaine, alkyldimethylbetaine, sulfobetaine, and combinations thereof.

The composition according to the instant invention can further comprise one or more auxiliary agents selected from the group consisting of bleaching systems, hydrotropes, polymers, which may be synthetic, biopolymers, anti-redeposition aids, fiber protection agents, soil release agents, dye transfer inhibitors, fabric hueing agents, opacifiers, blueing dyes, enzyme stabilizing agents, solvents, viscosity modifiers, preservatives, pH-regulators and salts like NaCl and Na₂SO₄.

Any polymer known in the art for use in detergents may be utilized. The polymer may function as a co-builder as mentioned above, or may provide antiredeposition, fiber protection, soil release, dye transfer inhibition, viscosity modifiers, grease cleaning and/or anti-foaming properties. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

Preferably a composition according to the instant invention is characterized in that it comprises at least one selected from anti-redeposition polymers and soil release polymers, with soil release polymers being preferred. This has the technical effect, that the cleaning capabilities of the composition according to the instant invention is even more enhanced. In combination with glycolipids, which bear one sugar ring in the molecule, e.g. like mono-rhamnolipids and glucolipids of formula (III) a surprising viscosity increase can be observed.

It is preferred in the context of the instant invention, that the anti-redeposition polymer or soil release polymer is selected from the group comprising, preferably consisting of, modified cellulose, preferably carboxymethylcellulose, cellulose acetate and methylcellulose, modified starch, modified inulin, preferably carboxy methyl inulin, polyitaconic acid, polyvinylpyrrolidone, polyvinyl alcohol, and polyethylene glycol, with carboxymethylcellulose and methylcellulose being most preferred.

Further preferred soil release polymers are water soluble polyesters as for example from the TexCare® range commercially available under the name TexCare SRN 260, TexCare SRN 170, TexCare SRN 260 Life and combinations thereof, as well, as the soil release polymers disclosed in EP3218461, EP3218465, EP3489340 and EP3489338.

Further preferred soil release polymers are selected from carboxy methyl inulins. A commercial example is Carboxyline®CMI.

This type of soil release polymer is especially useful in boosting the viscosity build-up, induced by a content of glycolipids, which bear one sugar ring in the molecule, e.g. like mono-rhamnolipids and glucolipids of formula (III).

EP1746109 discloses hybrid polymers of amylose and acrylates, that can also advantageously used in the composition of the instant invention as soil release polymers. A commercial example for this type of soil release polymers is Alcoguard® H 5941.

Non-limiting examples of biopolymers including: starch, like e.g. corn starch, Zea mays starch and tapioca starch, modified starch, like e.g. starch hydroxypropyltrimonium chloride and hydrolyzed corn starch, cellulose, bacterial cellulose, modified cellulose, like e.g. microcrystalline cellulose, hydroxypropyl methylcellulose and cetyl hydroxyethylcellulose, guar gum, pectin, inulin, carrageenan, alginate, galactoarabinan, polycitronellol, carboxymethyl inulin, carboxymethyl cellulose, polyitaconic acid and combinations and salts thereof.

Suitable non-aqueous solvents include monohydric or polyhydric alcohols, alkanolamines or glycol ethers, provided they are miscible with water in the specified concentration range. The solvents are preferably selected from ethanol, n-propanol, i-propanol, butanols, glycol, propanediol, butanediol, glycerine, diglycol, propyldiglycol, butyldiglycol, hexylene glycol, ethylene glycol methyl ether, ethylene glycol ethyl ether, ethylene glycol propyl ether, n-butyl glycol ether, ethylene glycol mono-glycol ether, Diethylene glycol ethyl ether, propylene glycol methyl ether, propylene glycol ethyl ether, Propylene glycol propyl ether, dipropylene glycol monomethyl ether, dipropylene glycol monoethyl ether, diisopropylene glycol monomethyl ether, diisopropylene glycol monoethyl ether, methoxy triglycol, ethoxy triglycol, butoxy triglycol, 1-butoxyethoxy-2-propanol, n-butoxyethoxy-2-propanol, di-butoxyethoxy-2-propanol, 3-butyl-3-methoxyether solvents, and mixtures of these solvents, butoxyethoxy-2-propanol, 3-butyl-3-butyl ether, propyl glycol, di-octanol ether, di-butoxy-2-propanol, 3-butyl-3-butylether, propanol, propylenglycol, di-butoxyethoxy-2-propanol, di-butoxyethoxy-2-propanol, 3-butoxy-3-methoxyether solvents, diisopropylene glycol monomethylether, diisopropylene glycol monomethylether, and mixtures of these solvents. However, it is preferred that the surfactant preparation contains a polyol as the non-aqueous solvent. The polyol can comprise glycerol, 1,2-propanediol, 1,3-propanediol, ethylene glycol, diethylene glycol and/or dipropylene glycol.

Any preservative known in the art for use in detergents may be utilized. Exemplary preservatives include phenoxyethanol, sodium levulinate, sodium benzoate, p-anisic acid, potassium sorbate, benzoic acid, glyceryl caprylate, capryl glycol, penthylene glycol, methyl propane diol, bronopol, isothiazolinone (methylisothiazolinone, chloromethylisothiazolinone) and combinations thereof

Preferably the composition according to the instant invention comprises one or more encapsulate comprising a benefit agent, preferably a sensorial benefit agent. Preferred encapsulates in this context comprise shear/pressure-sensitive action encapsulates, whereby the sensorial benefit agent is released in response to mechanical force (e.g., friction, pressure, shear stress) on the encapsulate. The encapsulate shell is preferably comprised of materials including but not limited to polyurethane, polyamide, polyolefin, polysaccharide, protein, silicone, lipid, modified cellulose, gums, polyacrylate, polyphosphate, polystyrene, polyesters or combinations of these materials. Preferably the sensorial benefit agent comprises a skin benefit agent or an olfactory benefit agent and/or may be a volatile benefit agent. Sensorial benefit agents may also have benefits for hair and/or hard surfaces and/or fabrics. The sensorial benefit may have anti-foam properties, and as such it is advantageous for foaming purposes that it is encapsulated so as not interfering with the foam until release by rubbing. Suitable volatile benefit agents include but are not limited to perfumes, insect repellents, essential oils, sensates such as menthol and aromatherapy actives, preferably perfumes. Mixtures of volatile benefit agents may be used. The total amount of benefit agent is preferably from 0.01 to 10% by weight, more preferably from 0.05 to 5% by weight, even more preferably from 0.1 to 4.0%, most preferably from 0.15 to 4.0% by weight, based on the total weight of the composition. The preferred benefit agent is a perfume. The composition of the instant invention may also comprise an unconfined (also called non-encapsulated) volatile benefit agent. Where the volatile benefit agent is a perfume, the perfumes described below are suitable for use as the encapsulated volatile benefit agent and also as the unconfined perfume component.

Preferably the composition according to the instant invention comprises at least 90 wt.-%, preferably at least 95 wt.-%, more preferably at least 99 wt.-% non-petrochemical derived ingredients, with the weight percentages referring to the total composition.

Petrochemical derived ingredients can be identified by the content of stable carbon isotopic compositions (δ13C) to discriminate between non-petrochemical derived (like natural derived, e.g plant, microbiologic or animal derived) and petroleum derived ingredients.

Preferably the composition according to the instant invention comprises at least 90 wt.-%, preferably at least 95 wt.-%, more preferably at least 99 wt.-% ready biodegradable ingredients, with the weight percentages referring to the total composition.

Ingredients are tested for ready biodegradability according to OECD 301 A-F/ASTM D7373 (≥60% within 28 days) testing.

Water although not being degradable is, of course, considered ready biodegradable.

Preferably the composition according to the instant invention has a viscosity in the range of from 10 to 400, preferably of from 15 to 350, preferably of from 100 to 300, cPs (measured: Brookfield LV, s61, 200 rpm, 20° C.).

Preferably the composition according to the instant invention has a turbidity of from 0.005 to 5000, preferably of from 11.0 to 100, Nephelometric Turbidity Units. The measurement of turbidity is conducted with a 2100Q Portable Turbidimeter which measures the intensity of light scattered at 90 degrees as a beam of light passes through a liquid sample, giving a direct response in NTU. The NTU is a unit measuring the lack of clarity of liquids and is used by water and sewage treatment plants, in marine studies, for example. For example, water containing 1 milligram of finely divided silica per liter has a turbidity of 1 NTU. The water to be measured is placed in a standard container. A light beam passes through the water and strikes a sensor on the other side of the container. A second sensor is mounted at right angles to the beam, measuring light scattered by particles in the water. From the ratio between the light intensities at the two sensors the turbidity in NTU can be calculated.

The composition as contemplated herein preferably is a detergent composition. It may be in any convenient form, e.g., a bar, a homogenous tablet, a tablet having two or more layers, a pouch having one or more compartments, a regular or compact powder, a granule, a paste, a gel, or a regular, compact or concentrated liquid. There are a number of detergent formulation forms such as layers (same or different phases), pouches, as well as forms for machine dosing unit. Pouches can be configured as single or multicompartments. It can be of any form, shape and material which is suitable for hold the composition, e.g. without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC). Preferably the level of polymer in the film for example PVA is at least about 60%. Preferred average molecular weight will typically be from about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticisers like glycerol, ethylene glycerol, Propylene glycol, sorbitol and mixtures thereof. The pouches can comprise a solid laundry detergent composition or part components and/or a liquid cleaning composition or part components separated by the water soluble film. The compartment for liquid components can be different in composition than compartments containing solids, see for example US20090011970.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

The detergent composition according to the instant invention can be in form of a laundry soap bar and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval. The detergent composition according to the instant invention can be formulated as a granular detergent as described in WO09/092699, EP1705241, EP1382668, WO07/001262, U.S. Pat. No. 6,472,364, WO04/074419 or WO09/102854.

The detergent composition according to the instant invention preferably is in the form of a liquid or gel detergent. This may be aqueous, typically containing at least 20% by weight water, with the percentages referring to the total composition. Other types of liquids, including without limitation, alkanols, amines, diols, ethers and polyols may be included in an aqueous liquid or gel. An aqueous liquid or gel detergent composition may contain from 0-30 wt.-% organic solvent, with the percentages referring to the total composition. A liquid or gel detergent may be non-aqueous.

A preferred composition according to the invention is characterized in that the pH of the composition at 25° C. is from 3.0 to 10.0, preferably from 4.0 to 9.5 and particularly preferably from 7.0 to 9.0.

The “pH” in connection with the present invention—unless stated otherwise—is defined as the value which is measured for the relevant composition at 25° C. after stirring for five minutes using a pH electrode calibrated in accordance with ISO 4316 (1977).

The instant invention further provides a process for cleaning a surface of an article, preferably a textile or a fabric, comprising the steps of
a) providing a composition according to the instant invention and an article,
b) combining the provided composition and the provided article with water,
c) maintaining the temperature of the water comprising the provided composition and the provided article in a temperature range of from 15° C. to 100° C., preferably from 25° C. to 65° C., more preferably from 35° C. to 45° C., over a period of time of from 15 minutes to 240 minutes, preferably from 30 minutes to 180 minutes, more preferably from 45 minutes to 120 minutes, while tentatively moving the provided article in the water,
d) separating the article from the water, and optionally
e) rinsing the article with further water.

A preferred process according to the instant invention is characterized in that the weight ratio of the provided article and water in step b) and c) are in the range of from 1:2 to 1:20, preferably from 1:3 to 1:10, more preferably from 1:4 to 1:8.

A preferred process according to the instant invention is characterized in that in step b) per kg of water 0.1 g to 50 g, preferably 1.0 g to 20 g, more preferably 2.0 g to 10 g, composition according to the instant invention are provided.

The instant invention further provides the use of a composition according to the instant invention for cleaning a surface of an article, preferably a textile or a fabric.

Preferably the use according to the instant invention is characterized in that the surface of the article is cleaned from fat and/or oil, preferably from solid fatty stains.

The examples adduced hereinafter describe the present invention by way of example, without any intention that the invention, the scope of application of which is apparent from the entirety of the description and the claims, be restricted to the embodiments specified in the examples.

### EXAMPLES

### Example 1

The following formulations were prepared with the numbers given being weight percentages of active matter, Benchmark 1 and Benchmark 2 (commercially available detergents) being not according to the invention, BIO_1.1 to BIO_3.3 according to the invention:

TABLE 1

| Ingredient | BIO_1.1 | BIO_1.2 | BIO_2.1 | BIO_2.2 | BIO_3.1 | BIO_3.2 | BIO_3.3 |
|---|---|---|---|---|---|---|---|
| Na soap from | 5 | 5 | 5 | 5 | 2 | 2 | 2 |
| palm kernel oil | | | | | | | |
| Sodium Citrate | 6 | 6 | 6 | 6 | 6 | 6 | 6 |
| RAMNOLIPIDS | 15 | 15 | 20 | 20 | 15 | 15 | 15 |
| Trilon ® M | — | — | — | — | — | 1 | 1 |
| Phenoxyethanol | 0.45 | 0.45 | 0.45 | 0.45 | 0.45 | 0.45 | 0.45 |
| Liquanase, 2.5 L | 0.7 | 0.7 | 0.7 | 0.7 | 0.7 | 0.7 | 1 |
| Amplify ® Prime | 0.4 | 0.4 | 0.4 | 0.4 | 0.4 | 0.4 | 0.4 |
| 100 L | | | | | | | |
| Lipex ® 100 L | — | 0.4 | — | 0.4 | 0.4 | 0.4 | 0.4 |
| Evity (NZ) | | | | | | | |
| Lipase from | 0.4 | — | 0.4 | — | — | — | — |
| CN104031899 | | | | | | | |
| Mannaway ® 4.0 | 0.2 | 0.2 | 0.2 | 0.2 | 0.2 | 0.2 | 0.2 |
| L | | | | | | | |
| | Add | Add | Add | Add | Add | Add | Add |
| | water to | water to | water to | water to | water to | water to | water to |
| | 100% | 100% | 100% | 100% | 100% | 100% | 100% |
| pH | 8.5 | 8.5 | 8.4 | 8.4 | 8.5 | 8.4 | 8.4 |

In the above, a mixture of rhamnolipids as listed below was used:

| | |
|---|---|
| RL total [%] (HPLC) | 91 |
| diRL-C8C10 | 13.9 |
| monoRL-C8C10 | 0.51 |
| diRL-C10C10 | 61.4 |
| monoRL -C10C10 | 1.4 |
| diRL-C10C12:1 | 5.9 |
| diRL-C10C12 | 5.5 |
| other RL | 2.2 |

Benchmark 1 (Commercial product):

| | |
|---|---|
| Texapon N70 | 14 |
| Eltesol SX40 | 1.08 |
| Dehydol LT7 | 8.5 |
| NaOH | 1.83 |
| Na soap from palm kernel oil | 5 |
| Sodium Citrate | 3.5 |
| Dequest 2066 | 2.37 |
| Ethanol | 2.5 |
| Acticide SR150 | 0.45 |
| Liquanase, 2.5 L | 0.7 |
| Amplify Prime | |
| 100 L | 0.4 |
| Lipex 100 L Evity | 0.4 |
| | Add water to 100% |
| pH | 8.4 |

Benchmark 2 (Commercial product)

| | |
|---|---|
| Texapon N70 | 4.2% |
| Dehydol LT7 | 12.3% |
| Glyceryl Cocoate Peg 30 | 8.4 |
| Potassium Oleate | 8.0% |
| Polyquarternium PQ 6 | 0.5% |
| Sodium citrate | 8.0% |
| Lactic Acid | 3.0% |
| Perfume | 0.5% |
| Ethanol (denatured, 96%) | 8.5% |
| Glycerin | 6.0% |
| Liquanase, 2.5 L | 0.5% |
| Stainzyme Plus 12 L | 0.2% |
| Celluclean 4500 L | 0.2% |
| | Add water to 100% |
| pH | 7.95 |

For the evaluation of the compositions in table 1, a stain removal test has been carried out 2 cycles for the stain removal and has been done for 14 standard stains plus 8 additional fat stains, following the A.I.S.E test (reduced). The test was performed at 40° C.

In this performance test, two cycles (replicates) were considered for the compositions.

The water used had a water hardness of 14° deutsche Haerte.

A programmable Miele electronic household washing machine was used. Fuzzy logic type control was disabled. The washing program is listed are explained in the following table:

TABLE 2

| | Cotton wash program (at 40° C.) | |
|---|---|---|
| Duration Main Wash | 70 | min |
| Total Program Duration | 120 | min |
| Water Quantity Main Wash | (15 ± 2) L | |
| Total Water Quantity | (55 ± 5) L | |
| Number of Rinse Cycles | 3 | |
| Final Spin Speed | 1200 | rpm |

3 kg of standardized cotton load was previously washed at 60° C. with ECE2 detergent without bleach.

A set of 14 current A.I.S.E. stains set for each replicate was used (purchased form CFT, MON-AISE A+B). The different stains are shown in Table 3.

TABLE 3

| | Stain classes (Consumer denomination/ |
|---|---|
| Stains | chemical nature) |
| Fruit juice | Drink/Bleachable |
| Tee | Drink/Bleachable |
| Grass | General soil/Bleachable - enzymatic |
| Unused motor oil | Grease, oil/Greasy particulate |
| Make up | Cosmetic/Greasy particulate |
| Red wine | Drink/Bleachable |
| Coffee | Drink/Bleachable |
| Tomato Puree | Food/Bleachable |
| Salad Dressing/Balsamico | Food/Bleachable-Enzymatic |
| Blood | General Soil/Enzymatic |
| French Squeezy Mustard | Food/Bleachable-Enzymatic |
| Chocolate | Food/Enzymatic |
| Grass/Mud | General Soil/Bleachable-enzymatic- |
| | particulate |
| Beef fat | Grease, oil/Greasy - Enzymatic |

A set of 8 fatty stains set for each replicate was used. The different stains are shown in Table 4.

TABLE 4
Stains

| | | |
|---|---|---|
| Lipstick diluted red (instead of another | Grease, oil/Greasy - | C-S-216 |
| make up stain) | Enzymatic | |
| Carbon black/olive oil | Grease, oil/Greasy | E-106 |
| IEC carbon black/mineral oil | Grease, oil/Greasy | C-01 |
| Butterfat with colorant | Grease, oil/Greasy - | C-S-10 |
| | Enzymatic | |
| High discriminative sebum | Grease, oil/Greasy - | C-S-132 |
| | Enzymatic | |
| Olive oil with chlorophyl | Grease, oil/Greasy - | C-04 |
| | Enzymatic | |
| Beef fat, colored with sudan red | Grease, oil/Greasy - | C-S-61 |
| | Enzymatic | |
| 50% lard, 50% Beef fat with colorant | Grease, oil/Greasy - | C-S-63s |
| | Enzymatic | |

The used stains were purchased form CFT (Vlaardingen, Nederland's) which was also recommended by A.I.S.E (Laundry Detergent Testing Guidelines)

Together with the 3 kg of ballast load and two new units of soil SBL2004, the set of 14 standard stains and the 8 additional fat stains were introduced in each wash cycle. SBL2004 is the ‘standard’ Soil Ballast from wfk; 100% cotton, approximative 8 g soil/swatch were used for testing laundry processes.

50 g of each composition was used in the washing process.

The evaluation of the degree of stain removal was carried out measuring the reflectance via spectrophotometer, using the Y-value of the Y, x, y color coordinates measurement, light source D65 with a UV cut-off filter at 420 nm. Aperture used for real stains 15 mm (minimum 12 mm). Stains were measured unfolded, 2 measurements per stain (in the center of the circular area, or closest homogenous area). Measurements were taken on each stain before wash (to verify quality of stains) and after the wash and to evaluate standard deviations and are reported. Results are expressed as the mean of value Y between two replicates and its standard deviation and shown in table 5 and 6. The better the soil removal, the larger the Y value.

TABLE 5a

| | | Benchmark 1 | | Benchmark 2 | |
|---|---|---|---|---|---|
| STAIN | # | Avarage | σ | Avarage | σ |
| Fruit Juice | 1 | 60.61 | 0.04 | 51.99 | 0.77 |
| Tea | 2 | 75.32 | 1.22 | 65.15 | 0.28 |
| Grass | 3 | 83.18 | 0.35 | 72.11 | 7.38 |
| Motor oil | 4 | 51.41 | 1.71 | 53.83 | 1.83 |
| Make up | 5 | 71.99 | 3.44 | 61.69 | 0.21 |
| Red Wine | 6 | 55.42 | 0.13 | 48.1 | 1.57 |
| Coffe | 7 | 59.62 | 2.18 | 53.13 | 1.12 |
| Tomato Puree | 8 | 70.5 | 2.15 | 67.96 | 3.43 |
| Salad Dressing Balsamico | 9 | 77.57 | 1.54 | 62.65 | 3.8 |
| Blood | 10 | 71.76 | 0.55 | 64.49 | 4.48 |
| Freench squeezy mustard | 11 | 80.7 | 1.48 | 74.85 | 0.02 |
| Chocolate | 12 | 56.96 | 0.89 | 54.37 | 0.05 |
| Grass/mud | 13 | 56.4 | 1.38 | 38.84 | 1.27 |
| Beef fat | 14 | 70.08 | 0.19 | 66.28 | 0.98 |

| | | |
|---|---|---|
| % stain removal (AISE stains) | 67.25 | 59.67 |
| Total | 941.5 | 835.39 |

TABLE 5b

| | | BIO_1.1 | | BIO_1.2 | |
|---|---|---|---|---|---|
| STAIN | # | Avarage | σ | Avarage | σ |
| Fruit Juice | 1 | 56.44 | 1.36 | 57.36 | 1.77 |
| Tea | 2 | 65.2 | 2.18 | 64.32 | 0.56 |
| Grass | 3 | 78.57 | 4.68 | 73.48 | 6.38 |
| Motor oil | 4 | 51.96 | 1.58 | 50.69 | 1.36 |
| Make up | 5 | 65.12 | 1.32 | 67.39 | 0.97 |
| Red Wine | 6 | 50.12 | 0.29 | 49.45 | 1.06 |
| Coffe | 7 | 56.28 | 0.04 | 55.59 | 1.7 |
| Tomato Puree | 8 | 66.38 | 3.3 | 65.34 | 3.1 |
| Salad Dressing Balsamico | 9 | 71.73 | 5.35 | 68.57 | 2.98 |
| Blood | 10 | 70.93 | 0.11 | 71.08 | 0.13 |
| Freench squeezy mustard | 11 | 74.83 | 1.91 | 74.42 | 2.11 |
| Chocolate | 12 | 55.41 | 0.16 | 55.16 | 0.23 |
| Grass/mud | 13 | 54.98 | 3.04 | 56.29 | 1.56 |
| Beef fat | 14 | 65.99 | 1.58 | 69.24 | 1.24 |

| | | |
|---|---|---|
| % stain removal (AISE stains) | 63.14 | 62.74 |
| Total | 883.94 | 878.35 |

TABLE 5c

| | | BIO_2.1 | | BIO_2.2 | |
|---|---|---|---|---|---|
| STAIN | # | Avarage | σ | Avarage | σ |
| Fruit Juice | 1 | 57.19 | 2.88 | 57.35 | 1.81 |
| Tea | 2 | 65.64 | 1.54 | 64.2 | 0.88 |
| Grass | 3 | 77.24 | 5.35 | 74.93 | 5.9 |
| Motor oil | 4 | 52.56 | 2.64 | 49.18 | 2.18 |
| Make up | 5 | 68.02 | 6.26 | 66.93 | 3.68 |
| Red Wine | 6 | 50.37 | 0.18 | 49.52 | 0.66 |
| Coffe | 7 | 57.48 | 4.93 | 55.31 | 0.47 |
| Tomato Puree | 8 | 67.18 | 3.87 | 66.64 | 3.1 |
| Salad Dressing Balsamico | 9 | 70.88 | 3.89 | 69.19 | 3.84 |
| Blood | 10 | 74.99 | 2.45 | 73.7 | 3.07 |
| Freench squeezy mustard | 11 | 76.27 | 2.78 | 75.15 | 1.89 |
| Chocolate | 12 | 54.96 | 0.22 | 55.44 | 0.09 |
| Grass/mud | 13 | 55.53 | 3.03 | 55.14 | 1.1 |
| Beef fat | 14 | 65.14 | 1.31 | 69.79 | 0.54 |

| | | |
|---|---|---|
| % stain removal (AISE stains) | 63.82 | 63.03 |
| Total | 893.41 | 882.43 |

TABLE 5d

| | | BIO_3.1 | | BIO_3.2 | | BIO_3.3 | |
|---|---|---|---|---|---|---|---|
| STAIN | # | Avarage | σ | Avarage | σ | Avarage | σ |
| Fruit Juice | 1 | 52.4 | 0.57 | 54.79 | 0.91 | 54.79 | 0.93 |
| Tea | 2 | 63.35 | 0.37 | 64.99 | 0.54 | 64.67 | 1.21 |
| Grass | 3 | 70.57 | 6.92 | 74.41 | 6.98 | 72.23 | 5.11 |
| Motor oil | 4 | 49.54 | 1.76 | 49.43 | 0.22 | 49.1 | 1.73 |
| Make up | 5 | 62.95 | 0.19 | 65.62 | 0.98 | 65 | 0.47 |
| Red Wine | 6 | 47.95 | 2.86 | 50.89 | 0.13 | 50.54 | 1.1 |
| Coffe | 7 | 55.73 | 1.85 | 54.93 | 1.77 | 53.7 | 3.26 |
| Tomato Puree | 8 | 64.28 | 0.66 | 72.54 | 1.91 | 71.84 | 1.73 |
| Salad Dressing Balsamico | 9 | 65.22 | 1.1 | 67.46 | 2.32 | 67.26 | 1.54 |
| Blood | 10 | 70.09 | 1.8 | 72.29 | 0.8 | 69.31 | 2.45 |
| Freench squeezy mustard | 11 | 73.48 | 1.76 | 73.69 | 2.53 | 73.09 | 1.36 |
| Chocolate | 12 | 54.91 | 0.23 | 55.7 | 0.53 | 55.53 | 0.33 |
| Grass/mud | 13 | 52.61 | 0.11 | 53.47 | 0.28 | 53.19 | 1.61 |
| Beef fat | 14 | 70.43 | 0.74 | 79.65 | 0.08 | 79.47 | 0.36 |

| | | | |
|---|---|---|---|
| % stain removal (AISE stains) | 60.96 | 63.56 | 62.83 |
| Total | 853.47 | 889.82 | 870.68 |

### Additional Fatty Stains Table 6

TABLE 6a

| | Benchmark 1 | | Benchmark 2 | |
|---|---|---|---|---|
| STAIN | Average | σ | Average | σ |
| Lipstick diluted red | 60.83 | 0.26 | 58.75 | 2.76 |
| Carbon black/olive oil | 32.75 | 1.07 | 30.91 | 1.03 |
| IEC carbon black/mineral oil | 42.29 | 2.26 | 39.43 | 2.25 |
| Butterfat with colourant | 71.33 | 1.21 | 67.12 | 0.64 |
| High discriminative sebum | 65.27 | 0.38 | 63.68 | 0.91 |
| Olive oil with chlorophyl | 55.2 | 0.05 | 54.17 | 1.11 |
| 50% lard. 50% Beef fat with colorant | 53.25 | 1.88 | 39.11 | 4.14 |
| Beef fat. coloured with sudan red | 37.84 | 1.05 | 35.4 | 0.39 |

| | | |
|---|---|---|
| % stain removal (AISE stains) | 52.34 | 48.57 |
| Total | 418.75 | 388.54 |

TABLE 6b

| | BIO_1.1 | | BIO_1.2 | |
|---|---|---|---|---|
| STAIN | Average | σ | Average | σ |
| Lipstick diluted red | 65.37 | 4.01 | 66.18 | 5.26 |
| Carbon black/olive oil | 33.75 | 0.48 | 30.24 | 4.45 |
| IEC carbon black/mineral oil | 40.15 | 2.76 | 41.45 | 0.86 |
| Butterfat with colourant | 67.01 | 1.97 | 67.68 | 0.01 |
| High discriminative sebum | 62.88 | 1.21 | 63 | 2.01 |
| Olive oil with chlorophyl | 55.05 | 0.42 | 55.25 | 0.33 |
| 50% lard. 50% Beef fat with colorant | 47.2 | 1.79 | 48.99 | 0.93 |
| Beef fat. coloured with sudan red | 41.86 | 0.08 | 39.87 | 0.11 |

| | | |
|---|---|---|
| % stain removal (AISE stains) | 51.66 | 51.58 |
| Total | 413.27 | 412.65 |

TABLE 6c

| | BIO_2.1 | | BIO_2.2 | |
|---|---|---|---|---|
| STAIN | Average | σ | Average | σ |
| Lipstick diluted red | 67.67 | 0.84 | 65 | 2.65 |
| Carbon black/olive oil | 29.92 | 2.16 | 31.36 | 2.89 |
| IEC carbon black/mineral oil | 39.58 | 2 | 38.26 | 2.02 |
| Butterfat with colourant | 67.21 | 1.41 | 68.21 | 0.25 |
| High discriminative sebum | 63.54 | 1.76 | 60.54 | 1.89 |
| Olive oil with chlorophyl | 55.31 | 0.83 | 55.41 | 1.05 |
| 50% lard. 50% Beef fat with colorant | 47.22 | 0.86 | 45.98 | 1.61 |
| Beef fat. coloured with sudan red | 40.99 | 2.78 | 40.09 | 3.1 |

| | | |
|---|---|---|
| % stain removal (AISE stains) | 51.43 | 50.6 |
| Total | 411.42 | 404.82 |

TABLE 6d

| | BIO_3.1 | | BIO_3.2 | | BIO_3.3 | |
|---|---|---|---|---|---|---|
| STAIN | Average | σ | Average | σ | Average | σ |
| Lipstick diluted red | 61.71 | 2.56 | 61.51 | 0.29 | 61.4 | 0.39 |
| Carbon black/olive oil | 32.3 | 1.69 | 31.54 | 0.28 | 33.16 | 0.31 |
| IEC carbon black/mineral oil | 36.25 | 0.29 | 37.16 | 1.45 | 35.58 | 1.27 |
| Butterfat with colourant | 66.14 | 0.07 | 78.75 | 0.54 | 78.34 | 0.71 |
| High discriminative sebum | 60.88 | 0.8 | 59.86 | 0.83 | 60.09 | 2.31 |
| Olive oil with chlorophyl | 55.3 | 0.36 | 55.61 | 0.27 | 54.28 | 0.12 |
| 50% lard. 50% Beef fat with colorant | 35.98 | 0.87 | 58.51 | 0.28 | 54.85 | 0.42 |
| Beef fat. coloured with sudan red | 36.38 | 1.48 | 58.41 | 2.21 | 57.84 | 0.93 |

| | | | |
|---|---|---|---|
| % stain removal (AISE stains) | 48.11 | 55.17 | 54.44 |
| Total | 384.91 | 441.33 | 435.52 |

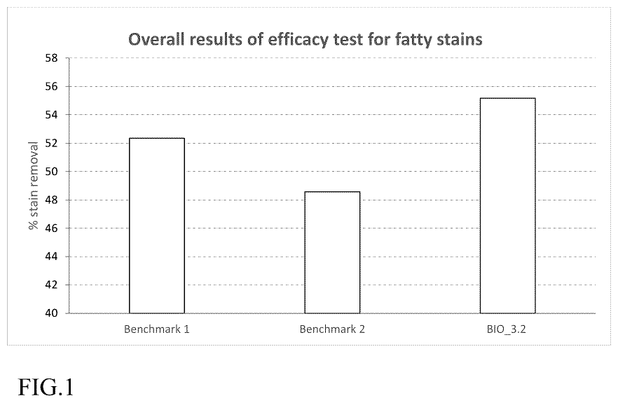

It was surprisingly found that the very simple composition according to the invention outperform biosurfactant based market products like Benchmark 2, having complicated mixtures of different ingredients formulated into. Moreover, the very simple composition according to the invention outperform both benchmarks with peak performance when it comes to blood stain and different fatty stains especially on beef fat and lipstick. Especially Bio 3.2 and Bio 3.3 show way better performance on fatty stains compared to the two benchmarks. (FIG. 1)

### Example 2

In a second example additionally formulations containing the whole enzyme cocktail Medley® Brilliant 300 L from Novozymes were tested for their cleaning properties.

Two different rhamnolipids were used in this example:

“Rhamnolipids 1” are those of example 1 above, “rhamnolipids 2” were prepared as described below and resemble mono-rhamnolipids:

The 35% by weight rhamnolipid solution prepared as described in example 1 was diluted to 1% by adding water. Two litres of this solution were heated to 50° C. With gentle stirring, 200 units of a thermostable rhamnosidase (ThermoActive™ Rhamnosidase A, Prokazyme) were added and the reaction was carried out overnight. After 20 h, a sample of the solution was analysed by means of HPLC. The di-rhamnolipid had been completely converted to mono-rhamnolipid and rhamnose. Then, the enzyme was deactivated for one hour at 80° C. The entire mixture was then freeze-dried. The freeze-dried product was adjusted to a mono-rhamnolipid active content of 35% by weight by adding water.

“Glucolipids” were produced according to example 2 of WO2019154970 via fermentation. Cells were separated by centrifugation at 10.000 g for 20 minutes. The fermentation broth was separated as the supernatant and adjusted to pH 3.1 by addition of concentrated H₂SO₄.

After a second centrifugation at 5.000 g for 20 minutes the aqueous upper phase was separated off and the remaining lower phase was a concentrate, which had a content of more than 50 wt.-% of glucolipids.

The following formulations were prepared with the numbers given being weight percentages of active matter, Benchmark 1, Benchmark 2 and Benchmark 3 (the same as in example 1) being not according to the invention, BIO_4.1—BIO_15 according to the invention:

TABLE 7

| Ingredient | BIO_4.1 | BIO_4.2 | BIO_4.3 |
|---|---|---|---|
| Na soap from palm kernel oil | 2 | 2 | 2 |
| Sodium Citrate | 6 | 6 | 6 |
| RAMNOLIPIDS 1 | 15 | — | — |
| RHAMNOLIPIDS 2 | — | 15 | — |
| GLUCOLIPIDS | — | — | 15 |
| Trilon ® M | 1 | 1 | 1 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.0 | 8.3 | 8.4 |

TABLE 8

| Ingredient | BIO_5 | BIO_6 | BIO_7 |
|---|---|---|---|
| Na soap from palm kernel oil | 2 | 2 | 2 |
| Sodium Citrate | 6 | 6 | 6 |
| RAMNOLIPIDS 1 | 15 | 15 | 20 |
| RHAMNOLIPIDS 2 | — | — | — |
| GLUCOLIPIDS | — | — | — |
| Trilon ® M | 1 | 1 | 1 |
| FAEO (C12-18 7EO) | — | 5 | — |
| Phenoxyethanol | 0.45 | 0.45 | 0.45 |
| NaOH (water solution) | 1.6 | 1.6 | 1.6 |
| Medley ® Brilliant 300 L | 3 | 2 | 2 |
| | Add water | Add water | Add water |
| | to 100% | to 100% | to 100% |
| pH | 8.3 | 8.3 | 8.4 |

TABLE 9

| Ingredient | BIO_8 | BIO_9 | BIO_9A |
|---|---|---|---|
| Na soap from palm kernel oil | 2 | 2 | 2 |
| Sodium Citrate | 6 | 6 | 6 |
| RAMNOLIPIDS 1 | 15 | 10 | 5 |
| RHAMNOLIPIDS 2 | — | — | 5 |
| GLUCOLIPIDS | — | — | — |
| Trilon ® M | 1 | 1 | 1 |
| FAEO (C12-18 7EO) | | 10 | 10 |
| Phenoxyethanol | 0.45 | 0.45 | 0.45 |
| NaOH (water solution) | 1.6 | 1.6 | 1.6 |
| Medley ® Brilliant 300 L | | 2 | 2 |
| | Add water | Add water | Add water |
| | to 100% | to 100% | to 100% |
| pH | 8.4 | 8.4 | 8.4 |

TABLE 10

| Ingredient | BIO_10 | BIO_11 | BIO_11A |
|---|---|---|---|
| Na soap from palm kernel oil | 2 | 2 | 2 |
| Sodium Citrate | 6 | 6 | 6 |
| RAMNOLIPIDS 1 | 15 | 15 | 7 |
| RHAMNOLIPIDS 2 | — | — | 8 |
| GLUCOLIPIDS | — | — | — |
| Trilon ® M | 1 | 1 | 1 |
| TexCare ® SRN 260 Life | 0.5 | 1.5 | 1.5 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.2 | 8.1 | 8.1 |

TABLE 11

| Ingredient | BIO_12.1 | BIO_12.2 | BIO_12.2A |
|---|---|---|---|
| Na soap from palm kernel oil | 2 | 2 | 2 |
| Sodium Citrate | 6 | 6 | 6 |
| RAMNOLIPIDS 1 | 15 | | 7.5 |
| RHAMNOLIPIDS 2 | — | 15 | 7.5 |
| GLUCOLIPIDS | — | — | — |
| Trilon ® M | 1 | 1 | 1 |
| Carboxy methyl inulin) | 1 | 1 | 1 |
| Carboxyline ®CMI | | | |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 12

| Ingredient | BIO_13.1 | BIO_13.2 | BIO_13.2A |
|---|---|---|---|
| Na soap from palm kernel oil | 2 | 2 | 2 |
| Sodium Citrate | 6 | 6 | 6 |
| RAMNOLIPIDS 1 | 15 | | 10 |
| RHAMNOLIPIDS 2 | — | 15 | 5 |
| Trilon ® M | 1 | 1 | 1 |
| Carboxy methyl inulin) | 1.5 | 1.5 | 1.5 |
| Carboxyline ®CMI | | | |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 13

| Ingredient | BIO_14 | BIO_15 | BIO_15A |
|---|---|---|---|
| Na soap from palm kernel oil | 2 | 2 | 2 |
| Sodium Citrate | 6 | 6 | 6 |
| RAMNOLIPIDS 1 | 15 | | 5 |
| RHAMNOLIPIDS 2 | | 15 | 10 |
| Trilon ® M | 1 | 1 | 1 |
| Carboxy methyl inulin) | | 1 | 1 |
| Carboxyline ®CMI | | | |
| TexCare ® SRN 260 Life | 1 | | |
| FAEO (C12-18 7EO) | 5 | 5 | 5 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.1 | 8.1 |

Benchmark 1 (Commercial product):

| | |
|---|---|
| Texapon N70 | 14 |
| Eltesol SX40 | 1.08 |
| Dehydol LT7 | 8.5 |
| NaOH | 1.83 |
| Na soap from palm kernel oil | 5 |
| Sodium Citrate | 3.5 |
| Dequest 2066 | 2.37 |
| Ethanol | 2.5 |
| Acticide SR150 | 0.45 |
| Liquanase, 2.5 L | 0.7 |
| Amplify Prime | |
| 100 L | 0.4 |
| Lipex 100 L Evity | 0.4 |
| | Add water to 100% |
| pH | 8.4 |

Benchmark 2 (Commercial product)

| | |
|---|---|
| Texapon N70 | 4.2% |
| Dehydol LT7 | 12.3% |
| Glyceryl Cocoate Peg 30 | 8.4 |
| Potassium Oleate | 8.0% |
| Polyquarternium PQ 6 | 0.5% |
| Sodium citrate | 8.0% |
| Lactic Acid | 3.0% |
| Perfume | 0.5% |
| Ethanol (denatured, 96%) | 8.5% |
| Glycerin | 6.0% |
| Liquanase, 2.5 L | 0.5% |
| Stainzyme Plus 12 L | 0.2% |
| Celluclean 4500 L | 0.2% |
| | Add water to 100% |
| pH | 7.95 |

Benchmark 3 (Commercial product)

| | |
|---|---|
| LAS | 35.4% |
| SLES 2EO | 7.1% |
| FAEO C12-18, 7 EO | 10.0% |
| Coco fatty acid | 2.0% |
| Texcare SRN 170 | 1.4% |
| Methoxy PPG Methacroylcholine | 0.5% |
| Citric acid | 3.0% |
| Sodium citrate | 2.0% |
| HEDP (60% solution) | 3.3% |
| Perfume | 1.0% |
| Sorbitol (solution) | 2.9% |
| Glycerin | 2.0% |
| MPG | 11.0% |
| Monoethanolamine | 9.0% |
| Liquanase 3.5 L | 1.0% |
| Amplify Prime 100 L | 0.7% |
| Lipex 100 L Evity | 0.4% |
| Mannaway 4.0 L | 0.2% |
| Xpect 1000 L | 0.2% |
| Celluclean 4500 L | 0.2% |
| Carezyme Premium 5000 L | 0.1% |
| | Add water to 100% |
| pH | 8.5 |

For the evaluation of the products, the stain removal test and whiteness grade test have been carried out: 2 cycles (replicates) for the stain removal for 14 standard stains plus 8 additional fat stains, following A.I.S.E test (reduced version); and 6 consecutives cycles for whiteness grade assay with four different textiles (Polyamide, Polyester, Polyester:Cotton and Cotton). This test has been done at 40° C. The protocol that has been followed for this comparison is the A.I.S.E. test published on its website and named “Minimum protocol for comparative detergent tests”.

A programmable Miele electronic household washing machine has been used for the development of this test. Fuzzy logic type control has been disabled. The conditions have been explained in the table 2:

The water used had a water hardness of 14° deutsche Haerte.

A programmable Miele electronic household washing machine was used. Fuzzy logic type control was disabled. The washing program is listed are explained in the following table: 3 kg of standardized cotton load was previously washed at 60° C. with ECE2 detergent without bleach.

A set of 14 current A.I.S.E. stains set for each replicate have been used. The different stains are shown in Table 3 and 4 Together with the 3 kg of ballast load, the set of 14-standard stains and 8-additional fat stains and 2 new units of soil SBL2004 have been introduced in each wash cycle.

For the evaluation of whiteness degree, four different textiles have been used:
Polyamide 100% (PA)
Polyester 100% (PES)
Polyester:Cotton 70:30 (PESCO)
Cotton 100% (CO)

The dosage of the samples was 50 mL for each product on study following the commercial instructions of benchmarks products.

The selected program for performance test has been Cotton, 40° C. and 1200 rpm for the centrifugation process.

The evaluation of stain removal and whiteness degree were carried out using the Y values of the colour coordinate measurements of Y, x, y, with a light source D65 and with a UV filter that cuts at 420 nm in a spectrophotometer.

Whiteness degree has been evaluated by Y-value in four Standard textiles (Polyamide, Polyester, Polyester:Cotton and Cotton) through 6 consecutive washes.

### Stain Removal Results

TABLE 14

| | | Benchmark 1 | | Benchmark 2 | | Benchmark 3 | |
|---|---|---|---|---|---|---|---|
| STAIN | # | Average | σ | Average | σ | Average | σ |
| Fruit Juice | 1 | 59.95 | 0.88 | 56.66 | 0.46 | 61.46 | 0.21 |
| Tea | 2 | 63.55 | 1.40 | 65.11 | 0.21 | 66.21 | 0.23 |
| Grass | 3 | 79.99 | 0.86 | 72.06 | 0.33 | 82.95 | 0.16 |
| Motor oil | 4 | 57.04 | 0.68 | 60.07 | 0.34 | 65.24 | 1.07 |
| Make up | 5 | 67.57 | 0.91 | 66.49 | 0.11 | 69.65 | 0.91 |
| Red Wine | 6 | 51.83 | 0.86 | 51.04 | 1.09 | 57.31 | 1.63 |
| Coffe | 7 | 53.30 | 1.27 | 53.63 | 0.67 | 54.13 | 0.95 |
| Tomato Puree | 8 | 65.25 | 0.95 | 66.00 | 1.33 | 67.50 | 0.84 |
| Salad Dressing Balsamico | 9 | 62.33 | 0.63 | 61.09 | 0.35 | 63.99 | 1.48 |
| Blood | 10 | 68.54 | 0.37 | 61.66 | 2.18 | 61.02 | 0.66 |
| Freench squeezy mustard | 11 | 74.81 | 0.31 | 76.95 | 0.45 | 79.40 | 0.36 |
| Chocolate | 12 | 54.50 | 0.49 | 54.36 | 0.07 | 55.45 | 0.36 |
| Grass/mud | 13 | 49.56 | 0.60 | 37.70 | 0.87 | 49.62 | 0.34 |
| Beef fat | 14 | 68.07 | 1.60 | 56.66 | 0.46 | 81.70 | 0.73 |

| | | | |
|---|---|---|---|
| % stain removal (AISE stains) | 62.59 | 60.94 | 65.40 |
| Total | 876.28 | 853.14 | 915.58 |

TABLE 15

| | Benchmark 1 | | Benchmark 2 | | Benchmark 3 | |
|---|---|---|---|---|---|---|
| STAIN | Average | σ | Average | σ | Avarage | σ |
| Lipstick diluted red | 61.02 | 0.08 | 58.99 | 1.15 | 63.45 | 1.68 |
| Carbon black/olive oil | 28.95 | 1.42 | 34.97 | 1.16 | 32.66 | 4.00 |
| IEC carbon black/mineral oil | 35.47 | 1.35 | 39.64 | 3.08 | 36.26 | 0.49 |
| Butterfat with colourant | 65.74 | 1.13 | 67.18 | 0.40 | 70.11 | 0.09 |
| High discriminative sebum | 55.57 | 1.70 | 55.58 | 0.11 | 56.04 | 0.83 |
| Olive oil with chlorophyl | 49.13 | 0.98 | 49.28 | 0.01 | 49.89 | 0.25 |
| 50% lard. 50% Beef fat with colorant | 32.54 | 0.78 | 36.68 | 1.92 | 58.55 | 3.62 |
| Beef fat. coloured with sudan red | 41.52 | 1.37 | 45.02 | 2.52 | 57.39 | 1.26 |

| | | | |
|---|---|---|---|
| % stain removal (AISE stains) | 46.24 | 48.42 | 53.04 |
| Total | 369.93 | 387.32 | 424.34 |

TABLE 16

| | | BIO_4.1 | | BIO_4.2 | | BIO_4.3 | |
|---|---|---|---|---|---|---|---|
| STAIN | # | Avarage | σ | Avarage | σ | Avarage | σ |
| Fruit Juice | 1 | 58.80 | 0.09 | 60.20 | 0.45 | 57.44 | 1.37 |
| Tea | 2 | 66.00 | 0.75 | 66.42 | 0.15 | 65.23 | 0.15 |
| Grass | 3 | 70.80 | 1.10 | 77.89 | 2.90 | 76.68 | 1.89 |
| Motor oil | 4 | 58.48 | 2.47 | 65.17 | 0.31 | 60.72 | 0.04 |
| Make up | 5 | 67.14 | 0.23 | 69.85 | 2.18 | 67.23 | 0.86 |
| Red Wine | 6 | 52.33 | 0.11 | 51.98 | 0.76 | 51.19 | 0.59 |
| Coffe | 7 | 53.53 | 1.49 | 53.23 | 0.35 | 52.30 | 0.81 |
| Tomato Puree | 8 | 71.77 | 1.93 | 68.19 | 0.20 | 67.04 | 1.51 |
| Salad Dressing Balsamico | 9 | 59.53 | 0.04 | 60.59 | 0.82 | 61.32 | 0.43 |
| Blood | 10 | 74.33 | 0.33 | 72.07 | 0.93 | 73.22 | 0.80 |
| Freench squeezy mustard | 11 | 75.09 | 0.04 | 73.82 | 1.36 | 73.86 | 0.66 |
| Chocolate | 12 | 54.41 | 0.09 | 53.80 | 0.84 | 53.90 | 0.71 |
| Grass/mud | 13 | 47.87 | 0.06 | 50.79 | 1.94 | 49.28 | 1.25 |
| Beef fat | 14 | 66.47 | 2.16 | 78.06 | 0.10 | 71.18 | 1.20 |

| | | | |
|---|---|---|---|
| % stain removal (AISE stains) | 62.61 | 64.43 | 62.90 |
| Total | 876.50 | 902.04 | 880.54 |

TABLE 17

| | BIO_4.1 | | BIO_4.2 | | BIO_4.3 | |
|---|---|---|---|---|---|---|
| STAIN | Average | σ | Average | σ | Avarage | σ |
| Lipstick diluted red | 59.38 | 0.30 | 59.47 | 0.77 | 62.34 | 2.37 |
| Carbon black/olive oil | 32.18 | 2.67 | 31.91 | 0.52 | 34.29 | 2.67 |
| IEC carbon black/mineral oil | 38.37 | 0.02 | 39.87 | 0.04 | 37.78 | 0.83 |
| Butterfat with colourant | 65.80 | 2.02 | 68.42 | 1.24 | 65.99 | 0.18 |
| High discriminative sebum | 53.10 | 0.36 | 55.19 | 1.15 | 54.43 | 0.69 |
| Olive oil with chlorophyl | 51.94 | 0.81 | 49.24 | 1.31 | 49.63 | 0.04 |
| 50% lard. 50% Beef fat with | 35.94 | 0.29 | 58.25 | 0.14 | 41.62 | 2.26 |
| colorant | | | | | | |
| Beef fat. coloured with sudan | 41.07 | 0.97 | 55.28 | 1.50 | 47.14 | 0.16 |
| red | | | | | | |

| | | | |
|---|---|---|---|
| % stain removal (AISE stains) | 47.22 | 52.20 | 49.15 |
| Total | 377.76 | 417.61 | 393.21 |

TABLE 18

| | | BIO_5 | | BIO_6 | | BIO_7 | |
|---|---|---|---|---|---|---|---|
| STAIN | # | Avarage | σ | Avarage | σ | Avarage | σ |
| Fruit Juice | 1 | 60.43 | 0.13 | 60.33 | 0.67 | 57.86 | 0.16 |
| Tea | 2 | 66.87 | 0.45 | 67.08 | 0.31 | 66.42 | 1.10 |
| Grass | 3 | 76.68 | 3.09 | 79.12 | 0.70 | 78.91 | 1.58 |
| Motor oil | 4 | 59.76 | 1.48 | 59.24 | 1.12 | 61.60 | 4.31 |
| Make up | 5 | 69.54 | 0.87 | 68.88 | 0.17 | 69.82 | 1.63 |
| Red Wine | 6 | 53.30 | 1.10 | 52.51 | 0.50 | 51.95 | 0.62 |
| Coffe | 7 | 57.44 | 0.20 | 53.98 | 2.46 | 55.28 | 3.42 |
| Tomato Puree | 8 | 67.06 | 2.22 | 67.08 | 1.97 | 72.08 | 2.93 |
| Salad Dressing Balsamico | 9 | 62.63 | 0.96 | 64.37 | 0.66 | 63.98 | 2.37 |
| Blood | 10 | 72.00 | 1.34 | 73.35 | 3.15 | 72.41 | 0.45 |
| Freench squeezy mustard | 11 | 75.71 | 0.35 | 76.60 | 0.82 | 74.91 | 0.93 |
| Chocolate | 12 | 54.52 | 0.18 | 54.35 | 0.34 | 54.40 | 0.65 |
| Grass/mud | 13 | 51.20 | 0.74 | 49.69 | 0.47 | 50.97 | 1.26 |
| Beef fat | 14 | 73.02 | 1.61 | 63.83 | 4.33 | 68.02 | 2.92 |

| | | | |
|---|---|---|---|
| % stain removal (AISE stains) | 64.30 | 63.60 | 64.18 |
| Total | 900.13 | 890.38 | 898.58 |

TABLE 19

| | BIO_5 | | BIO_6 | | BIO_7 | |
|---|---|---|---|---|---|---|
| STAIN | Average | σ | Average | σ | Avarage | σ |
| Lipstick diluted red | 59.10 | 0.27 | 59.15 | 1.03 | 62.18 | 0.18 |
| Carbon black/olive oil | 35.35 | 0.56 | 30.02 | 4.83 | 34.40 | 2.59 |
| IEC carbon black/mineral oil | 39.84 | 1.46 | 37.78 | 2.74 | 37.81 | 2.07 |
| Butterfat with colourant | 67.95 | 0.11 | 61.28 | 0.11 | 65.84 | 1.77 |
| High discriminative sebum | 54.00 | 1.02 | 55.75 | 0.87 | 53.79 | 0.83 |
| Olive oil with chlorophyl | 50.42 | 0.37 | 50.74 | 0.06 | 50.28 | 0.08 |
| 50% lard. 50% Beef fat with | 47.50 | 5.64 | 33.80 | 1.87 | 45.74 | 0.37 |
| colorant | | | | | | |
| Beef fat. coloured with sudan | 50.54 | 0.31 | 42.37 | 0.65 | 41.26 | 2.20 |
| red | | | | | | |

| | | | |
|---|---|---|---|
| % stain removal (AISE stains) | 50.59 | 46.36 | 48.91 |
| Total | 49.52 | 370.87 | 391.28 |

TABLE 20

| | | BIO_8 | | BIO_9 | |
|---|---|---|---|---|---|
| STAIN | # | Avarage | σ | Avarage | σ |
| Fruit Juice | 1 | 60.69 | 0.55 | 59.06 | 0.28 |
| Tea | 2 | 61.83 | 0.12 | 66.54 | 0.67 |
| Grass | 3 | 60.64 | 0.72 | 77.07 | 2.71 |
| Motor oil | 4 | 52.16 | 0.56 | 62.23 | 1.83 |
| Make up | 5 | 60.35 | 1.29 | 68.23 | 1.20 |
| Red Wine | 6 | 52.27 | 0.74 | 52.60 | 2.63 |
| Coffe | 7 | 51.55 | 1.13 | 55.59 | 2.97 |
| Tomato Puree | 8 | 68.52 | 0.04 | 68.27 | 1.51 |
| Salad Dressing Balsamico | 9 | 39.96 | 0.14 | 64.36 | 2.38 |
| Blood | 10 | 58.63 | 0.46 | 64.09 | 2.34 |
| Freench squeezy mustard | 11 | 69.38 | 1.75 | 77.54 | 0.06 |
| Chocolate | 12 | 51.32 | 0.06 | 55.44 | 0.45 |
| Grass/mud | 13 | 43.66 | 0.37 | 49.90 | 0.01 |
| Beef fat | 14 | 65.27 | 1.62 | 62.49 | 3.01 |

| | | |
|---|---|---|
| % stain removal (AISE stains) | 56.87 | 63.10 |
| Total | 796.19 | 883.35 |

| | BIO_8 | | BIO_9 | |
|---|---|---|---|---|
| STAIN | Average | σ | Average | σ |
| Lipstick diluted red | 55.74 | 0.32 | 64.51 | 2.62 |
| Carbon black/olive oil | 27.11 | 1.74 | 35.67 | 2.37 |
| IEC carbon black/mineral oil | 35.35 | 1.07 | 39.36 | 0.12 |
| Butterfat with colourant | 66.75 | 0.89 | 66.27 | 0.40 |
| High discriminative sebum | 52.81 | 0.39 | 57.89 | 0.16 |
| Olive oil with chlorophyl | 50.42 | 0.26 | 51.65 | 0.52 |
| 50% lard. 50% Beef fat with | 44.35 | 2.41 | 43.51 | 2.12 |
| colorant | | | | |
| Beef fat. coloured with sudan | 41.22 | 4.37 | 41.98 | 1.77 |
| red | | | | |

| | | |
|---|---|---|
| % stain removal (AISE stains) | 55.74 | 50.10 |
| Total | 27.11 | 400.82 |

TABLE 21

| | | BIO_10 | | BIO_11 | |
|---|---|---|---|---|---|
| STAIN | # | Avarage | σ | Avarage | σ |
| Fruit Juice | 1 | 59.56 | 0.04 | 59.31 | 0.68 |
| Tea | 2 | 66.62 | 0.40 | 66.19 | 2.26 |
| Grass | 3 | 78.08 | 4.62 | 81.94 | 1.44 |
| Motor oil | 4 | 58.61 | 0.54 | 62.71 | 5.55 |
| Make up | 5 | 70.08 | 0.49 | 71.45 | 1.10 |
| Red Wine | 6 | 53.34 | 0.21 | 52.84 | 1.34 |
| Coffe | 7 | 56.55 | 1.91 | 56.77 | 3.51 |
| Tomato Puree | 8 | 72.05 | 2.06 | 74.36 | 1.72 |
| Salad Dressing Balsamico | 9 | 63.93 | 0.04 | 68.18 | 7.85 |
| Blood | 10 | 73.09 | 1.34 | 74.85 | 1.61 |
| Freench squeezy mustard | 11 | 75.35 | 0.21 | 76.85 | 0.26 |
| Chocolate | 12 | 55.67 | 0.11 | 54.66 | 0.59 |
| Grass/mud | 13 | 51.73 | 0.91 | 51.59 | 0.93 |
| Beef fat | 14 | 70.72 | 2.27 | 72.47 | 1.66 |

| | | |
|---|---|---|
| % stain removal (AISE stains) | 64.67 | 66.01 |
| Total | 905.35 | 924.13 |

TABLE 22

| | BIO_10 | | BIO_11 | |
|---|---|---|---|---|
| STAIN | Average | σ | Average | σ |
| Lipstick diluted red | 62.92 | 1.90 | 60.62 | 0.07 |
| Carbon black/olive oil | 36.16 | 0.50 | 35.38 | 1.65 |
| IEC carbon black/mineral oil | 39.39 | 0.22 | 37.38 | 0.03 |
| Butterfat with colourant | 66.90 | 0.97 | 67.62 | 1.63 |
| High discriminative sebum | 55.62 | 0.64 | 55.15 | 1.14 |
| Olive oil with chlorophyl | 50.98 | 0.21 | 50.40 | 0.30 |
| 50% lard. 50% Beef fat with | 46.84 | 1.97 | 46.65 | 2.72 |
| colorant | | | | |
| Beef fat. coloured with sudan | 44.63 | 2.71 | 44.94 | 2.04 |
| red | | | | |

| | | |
|---|---|---|
| % stain removal (AISE stains) | 50.43 | 49.77 |
| Total | 403.41 | 398.12 |

TABLE 23

| | | BIO_12.1 | | BIO_12.2 | |
|---|---|---|---|---|---|
| STAIN | # | Avarage | σ | Avarage | σ |
| Fruit Juice | 1 | 59.88 | 0.21 | 57.86 | 1.57 |
| Tea | 2 | 65.40 | 0.28 | 65.85 | 1.65 |
| Grass | 3 | 72.82 | 2.49 | 79.57 | 0.49 |
| Motor oil | 4 | 59.05 | 0.69 | 68.08 | 0.79 |
| Make up | 5 | 67.22 | 0.07 | 70.97 | 2.01 |
| Red Wine | 6 | 53.96 | 0.78 | 53.10 | 0.95 |
| Coffe | 7 | 53.58 | 1.18 | 54.55 | 0.64 |
| Tomato Puree | 8 | 72.69 | 1.84 | 71.67 | 2.28 |
| Salad Dressing Balsamico | 9 | 60.85 | 0.54 | 66.82 | 1.11 |
| Blood | 10 | 73.88 | 0.74 | 69.83 | 0.54 |
| Freench squeezy mustard | 11 | 76.10 | 0.37 | 75.13 | 0.02 |
| Chocolate | 12 | 54.30 | 0.25 | 54.42 | 0.10 |
| Grass/mud | 13 | 50.84 | 1.20 | 50.70 | 0.66 |
| Beef fat | 14 | 67.43 | 2.72 | 77.71 | 0.18 |

| | | |
|---|---|---|
| % stain removal (AISE stains) | 63.43 | 65.45 |
| Total | 887.96 | 916.23 |

TABLE 24

| | BIO_12.1 | | BIO_12.2 | |
|---|---|---|---|---|
| STAIN | Average | σ | Average | σ |
| Lipstick diluted red | 61.02 | 1.21 | 56.05 | 2.33 |
| Carbon black/olive oil | 32.09 | 2.32 | 34.59 | 0.77 |
| IEC carbon black/mineral oil | 40.77 | 0.59 | 39.85 | 3.14 |
| Butterfat with colourant | 66.10 | 1.70 | 67.66 | 0.47 |
| High discriminative sebum | 53.51 | 0.75 | 55.45 | 0.47 |
| Olive oil with chlorophyl | 50.68 | 0.08 | 48.63 | 0.70 |
| 50% lard. 50% Beef fat with | 45.53 | 0.97 | 58.47 | 0.49 |
| colorant | | | | |
| Beef fat. coloured with sudan | 43.47 | 2.38 | 55.31 | 0.28 |
| red | | | | |

| | | |
|---|---|---|
| % stain removal (AISE stains) | 49.14 | 52.00 |
| Total | 393.15 | 415.99 |

TABLE 25

| | | BIO_13.1 | | BIO_13.2 | |
|---|---|---|---|---|---|
| STAIN | # | Avarage | σ | Avarage | σ |
| Fruit Juice | 1 | 59.88 | 0.21 | 57.37 | 0.21 |
| Tea | 2 | 65.40 | 0.28 | 65.85 | 0.17 |
| Grass | 3 | 72.82 | 2.49 | 77.04 | 4.92 |
| Motor oil | 4 | 59.05 | 0.69 | 65.37 | 0.11 |
| Make up | 5 | 67.22 | 0.07 | 68.94 | 0.08 |
| Red Wine | 6 | 53.96 | 0.78 | 51.17 | 0.20 |
| Coffe | 7 | 53.58 | 1.18 | 53.95 | 1.41 |
| Tomato Puree | 8 | 72.69 | 1.84 | 71.19 | 1.71 |
| Salad Dressing Balsamico | 9 | 60.85 | 0.54 | 60.61 | 0.24 |
| Blood | 10 | 73.88 | 0.74 | 71.32 | 0.74 |
| Freench squeezy mustard | 11 | 76.10 | 0.37 | 74.32 | 0.07 |
| Chocolate | 12 | 54.30 | 0.25 | 53.44 | 0.34 |
| Grass/mud | 13 | 50.84 | 1.20 | 49.60 | 0.78 |
| Beef fat | 14 | 67.43 | 2.72 | 77.41 | 1.05 |

| | | |
|---|---|---|
| % stain removal (AISE stains) | 63.43 | 64.11 |
| Total | 887.96 | 897.57 |

TABLE 26

| | BIO_13.1 | | BIO_13.2 | |
|---|---|---|---|---|
| STAIN | Average | σ | Average | σ |
| Lipstick diluted red | 61.02 | 1.21 | 57.70 | 1.56 |
| Carbon black/olive oil | 32.09 | 2.32 | 31.04 | 3.04 |
| IEC carbon black/mineral oil | 40.77 | 0.59 | 39.72 | 3.04 |
| Butterfat with colourant | 66.10 | 1.70 | 67.92 | 0.69 |
| High discriminative sebum | 53.51 | 0.75 | 54.97 | 1.12 |
| Olive oil with chlorophyl | 50.68 | 0.08 | 48.70 | 1.16 |
| 50% lard. 50% Beef fat with | 45.53 | 0.97 | 57.41 | 2.15 |
| colorant | | | | |
| Beef fat. coloured with sudan | 43.47 | 2.38 | 55.20 | 2.24 |
| red | | | | |

| | | |
|---|---|---|
| % stain removal (AISE stains) | 49.14 | 51.58 |
| Total | 393.15 | 412.65 |

TABLE 27

| | | BIO_14 | | BIO_15 | |
|---|---|---|---|---|---|
| STAIN | # | Avarage | σ | Avarage | σ |
| Fruit Juice | 1 | 60.06 | 0.96 | 58.82 | 0.53 |
| Tea | 2 | 67.10 | 1.15 | 66.06 | 0.27 |
| Grass | 3 | 76.81 | 2.80 | 77.69 | 5.95 |
| Motor oil | 4 | 60.14 | 0.39 | 62.61 | 0.37 |
| Make up | 5 | 70.57 | 2.26 | 71.20 | 3.65 |
| Red Wine | 6 | 54.05 | 0.97 | 53.22 | 1.58 |
| Coffe | 7 | 56.19 | 2.97 | 56.42 | 3.15 |
| Tomato Puree | 8 | 70.09 | 2.80 | 72.77 | 2.03 |
| Salad Dressing Balsamico | 9 | 65.66 | 1.66 | 64.56 | 2.72 |
| Blood | 10 | 74.45 | 3.92 | 65.78 | 1.47 |
| Freench squeezy mustard | 11 | 77.74 | 1.27 | 76.92 | 0.08 |
| Chocolate | 12 | 56.23 | 0.26 | 54.77 | 0.20 |
| Grass/mud | 13 | 52.16 | 1.27 | 50.51 | 0.40 |
| Beef fat | 14 | 60.06 | 0.96 | 58.82 | 0.53 |

| | | |
|---|---|---|
| % stain removal (AISE stains) | 64.63 | 63.66 |
| Total | 904.85 | 891.22 |

TABLE 28

| | BIO_14 | | BIO_15 | |
|---|---|---|---|---|
| STAIN | Average | σ | Average | σ |
| Lipstick diluted red | 61.25 | 0.62 | 62.51 | 2.74 |
| Carbon black/olive oil | 32.92 | 5.30 | 34.91 | 0.83 |
| IEC carbon black/mineral oil | 41.36 | 2.14 | 38.07 | 1.51 |
| Butterfat with colourant | 65.11 | 1.97 | 66.12 | 2.82 |
| High discriminative sebum | 63.22 | 1.22 | 56.25 | 1.61 |
| Olive oil with chlorophyl | 50.18 | 0.06 | 51.61 | 0.86 |
| 50% lard. 50% Beef fat with | 42.48 | 0.30 | 46.78 | 0.81 |
| colorant | | | | |
| Beef fat. coloured with sudan | 41.05 | 1.97 | 42.62 | 0.74 |
| red | | | | |

| | | |
|---|---|---|
| % stain removal (AISE stains) | 49.69 | 49.86 |
| Total | 397.55 | 398.85 |

The stain removal evaluation of BIO_4-131O_15 is revealing that the overall performance of the formulations contained in the present invention increases when the enzyme cocktail Medley® Brilliant 300 L is being introduced. Additionally, the addition of a small concentration of the polymers TexCare® SRN 260 Life and Carboxyline®CMI is also leading to an overall performance increase.

The formulations according the invention show again a peek performance especially on stains like blood compared to benchmark indicating a clear synergy between the Rhamnolipids and the Glucolipids with the protease contained in the enzyme cocktail.

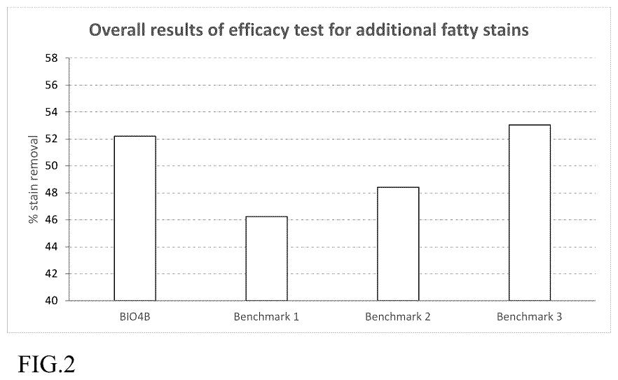

Especially the very simple formulations 4.2 according to the invention shows especially high performance when it comes to primary detergency, especially on solid fatty stains. The performance of 4.2 is comparable to the highly complex formulation of benchmark 3 which is a high performing standard on the market. (FIG. 2)

### Whiteness Degree Evaluation

TABLE 29

| | | Benchmark | Benchmark | Benchmark |
|---|---|---|---|---|
| | NO WASH | 1 | 2 | 3 |
| | ΔY | ΔY | ΔY | ΔY |
| Polyamine | 89.72 | 88.48 | 85.49 | 89.03 |
| Polyester | 85.13 | 84.00 | 82.87 | 85.03 |
| Polyester/ | 88.69 | 87.40 | 86.44 | 88.21 |
| Cotton | | | | |
| Cotton | 89.71 | 86.32 | 86.59 | 88.27 |

TABLE 30

| | NO WASH | BIO_4.1 | BIO_4.2 | BIO_4.3 |
|---|---|---|---|---|
| | ΔY | ΔY | ΔY | ΔY |
| Polyamine | 89.72 | 83.60 | 84.33 | 83.51 |
| Polyester | 85.13 | 77.08 | 82.28 | 81.36 |
| Polyester/Cotton | 88.69 | 86.28 | 88.82 | 87.50 |
| Cotton | 89.71 | 86.33 | 88.89 | 88.04 |

TABLE 31

| | NO WASH | BIO_5 | BIO_6 | BIO_7 |
|---|---|---|---|---|
| | ΔY | ΔY | ΔY | ΔY |
| Polyamine | 89.72 | 84.91 | 86.58 | 84.21 |
| Polyester | 85.13 | 82.89 | 82.10 | 81.65 |
| Polyester/Cotton | 88.69 | 87.64 | 88.47 | 87.57 |
| Cotton | 89.71 | 88.19 | 90.22 | 88.96 |

TABLE 32

| | NO WASH | BIO_8 | BIO_9 | BIO_10 | BIO_11 |
|---|---|---|---|---|---|
| | ΔY | ΔY | ΔY | ΔY | ΔY |
| Polyamine | 89.72 | 84.52 | 86.94 | 84.22 | 85.09 |
| Polyester | 85.13 | 72.92 | 82.04 | 84.63 | 85.07 |
| Polyester/ | 88.69 | 85.77 | 88.54 | 88.60 | 88.71 |
| Cotton | | | | | |
| Cotton | 89.71 | 86.83 | 89.82 | 88.55 | 87.37 |

TABLE 33

| | NO WASH | BIO_12.1 | BIO_13.1 | BIO_12.2 | BIO_13.2 |
|---|---|---|---|---|---|
| | ΔY | ΔY | ΔY | ΔY | ΔY |
| Polyamine | 89.72 | 83.78 | 84.05 | 83.85 | 83.80 |
| Polyester | 85.13 | 79.06 | 82.56 | 75.45 | 82.38 |
| Polyester/ | 88.69 | 86.96 | 87.90 | 86.72 | 87.98 |
| Cotton | | | | | |
| Cotton | 89.71 | 86.36 | 89.69 | 88.86 | 89.07 |

TABLE 34

| | NO WASH | BIO_14 | BIO_15 |
|---|---|---|---|
| | ΔY | ΔY | ΔY |
| Polyamine | 89.72 | 84.30 | 84.42 |
| Polyester | 85.13 | 83.59 | 80.37 |
| Polyester/Cotton | 88.69 | 87.97 | 87.33 |
| Cotton | 89.71 | 90.14 | 89.12 |

The evaluation of the whiteness degree of the products BIO_4 to BIO_15 is indicating that the compositions according to the instant invention are showing an overall good performance when it comes to secondary detergency compared to the benchmarks. The benchmark products have very complex formulation to achieve a good whiteness degree performance. Surprisingly it could be seen that the very simple formulations contained in the present invention have comparable performance with the benchmarks. In general, the formulations containing the rhamnolipids and/or the glucolipids show a very good performance on cotton and cotton/polyester textiles.

Addition of the soil release polymer TexCare® SRN 260 Life in BIO_10 and BIO_11 increases performance on Polyester textiles; which is quite surprising, as soil release polymers usually start to exert their function in the second wash after having deposited on the cloth in a first wash. To have an effect in cleaning in the first application thus was not foreseeable.

The FAEO in BIO_6 increases the effect on polyamine indicating a synergistic effect.

### Viscosity Effects:

The viscosity of formulations BIO_4.1, BIO_4.2, BIO_4.3, BIO_12.1, BIO_12.2, BIO_13.1 and BIO_13.2 was measured with a spindle 61 at 200 rpm and 20° C.

It was surprisingly found, that biosurfactants with only one sugar ring in the molecule give way higher viscosities than those with two sugar rings.

This effect is even even further enhanced, when an soil release polymer is present.

| | BIO_4.1 | BIO_4.2 | BIO_4.3 | BIO_12.1 | BIO_13.1 | BIO_13.2 | BIO_12.2 |
|---|---|---|---|---|---|---|---|
| Viscosity | 13.53 | 113.4 | 123.3 | 15.3 | 21.18 | 270.5 | 282.9 |
| (cPs, | | | | | | | |
| Brookfield | | | | | | | |
| LV, s61, | | | | | | | |
| 200 rpm, | | | | | | | |
| 20° C.) | | | | | | | |

### Formulation Examples

### Further Liquid Detergents:

TABLE 35

| Ingredient | BIO_16 | BIO_17 | BIO_18 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 15 | — |
| GLUCOLIPIDS | — | — | 15 |
| Poly L-Aspartic acid Sodium salt | 1.0 | 1.0 | 1.0 |
| Phenoxyethanol | 0.45 | 0.45 | 0.45 |
| Protease | 1.0 | 1.0 | 1.0 |
| Amylase | 0.4 | 0.4 | 0.4 |
| Lipase | 0.4 | 0.4 | 0.4 |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

TABLE 36

| Ingredient | BIO_19 | BIO_20 | BIO_21 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 20 | — |
| GLUCOLIPIDS | — | — | 20 |
| Poly-L-glutamic acid sodium | 1.0 | 1.0 | 1.0 |
| salt | | | |
| Phenoxyethanol | 0.45 | 0.45 | 0.45 |
| Protease | 1.2 | 1.2 | 1.2 |
| Amylase | 0.4 | 0.4 | 0.4 |
| Lipase | 0.4 | 0.4 | 0.4 |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

TABLE 37

| Ingredient | BIO_22 | BIO_23 | BIO_24 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 20 | — |
| GLUCOLIPIDS | — | — | 20 |
| Poly-L-glutamic acid sodium | 1.0 | 1.0 | 1.0 |
| salt | | | |
| Carboxy methyl inulin | 1.0 | 1.0 | 1.0 |
| Phenoxyethanol | 0.45 | 0.45 | 0.45 |
| Protease | 1.2 | 1.2 | 1.2 |
| Amylase | 0.4 | 0.4 | 0.4 |
| Lipase | 0.4 | 0.4 | 0.4 |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

TABLE 38

| Ingredient | BIO_25 | BIO_26 | BIO_27 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 20 | — |
| GLUCOLIPIDS | — | — | 20 |
| Poly-L-glutamic acid sodium | 1.0 | 1.0 | 1.0 |
| salt | | | |
| Carboxy methyl inulin | 1.0 | 1.0 | 1.0 |
| Phenoxyethanol | 0.45 | 0.45 | 0.45 |
| Protease | 1.0 | 1.0 | 1.0 |
| Amylase | 0.4 | 0.4 | 0.4 |
| Lipase from Stachybotrys | 0.4 | 0.4 | 0.4 |
| chlorohalonata | | | |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

TABLE 39

| Ingredient | BIO_28 | BIO_29 | BIO_30 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 20 | — |
| GLUCOLIPIDS | — | — | 20 |
| Carboxy methyl inulin | 3 | 3 | 3 |
| Phenoxyethanol | 0.45 | 0.45 | 0.45 |
| Protease | 1.0 | 1.0 | 1.0 |
| Amylase | 0.4 | 0.4 | 0.4 |
| Lipase from Stachybotrys | 0.4 | 0.4 | 0.4 |
| chlorohalonata | | | |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

TABLE 40

| Ingredient | BIO_31 | BIO_32 | BIO_33 |
|---|---|---|---|
| Na soap from palm kernel oil | 2.0 | 2.0 | 2.0 |
| Sodium Citrate | 6.0 | 6.0 | 6.0 |
| MGDA | 1 | 1 | 1 |
| RAMNOLIPIDS 1 | 20 | — | — |
| RHAMNOLIPIDS 2 | — | 20 | — |
| GLUCOLIPIDS | — | — | 20 |
| Poly-L-glutamic acid sodium | 1.0 | 1.0 | 1.0 |
| salt | | | |
| Carboxy methyl cellulose | 1.0 | 1.0 | 1.0 |
| Phenoxyethanol | 0.45 | 0.45 | 0.45 |
| Protease | 1.0 | 1.0 | 1.0 |
| Amylase | 0.4 | 0.4 | 0.4 |
| Lipase from Stachybotrys | 0.4 | 0.4 | 0.4 |
| chlorohalonata | | | |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.3 | 8.3 | 8.3 |

TABLE 41

| Ingredient | BIO_34 | BIO_35 | BIO_36 |
|---|---|---|---|
| Na soap from palm kernel oil | 2.0 | 2.0 | 2.0 |
| Sodium Citrate | 6.0 | 6.0 | 6.0 |
| MGDA | 1 | 1 | 1 |
| RAMNOLIPIDS 1 | 20 | — | — |
| RHAMNOLIPIDS 2 | — | 20 | — |
| GLUCOLIPIDS | — | — | 20 |
| Carboxy methyl cellulose | 3 | 3 | 3 |
| Phenoxyethanol | 0.45 | 0.45 | 0.45 |
| Protease | 1.0 | 1.0 | 1.0 |
| Amylase | 0.4 | 0.4 | 0.4 |
| Lipase from Stachybotrys | 0.4 | 0.4 | 0.4 |
| chlorohalonata | | | |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.3 | 8.3 | 8.3 |

TABLE 42

| Ingredient | BIO_37 | BIO_39 | BIO_40 |
|---|---|---|---|
| Na soap from palm kernel oil | 2.0 | 2.0 | 2.0 |
| Sodium Citrate | 6.0 | 6.0 | 6.0 |
| RAMNOLIPIDS 1 | 20 | — | — |
| RHAMNOLIPIDS 2 | — | 20 | — |
| GLUCOLIPIDS | — | — | 20 |
| Polyitaconic acid | 3 | 3 | 3 |
| Phenoxyethanol | 0.45 | 0.45 | 0.45 |
| Protease | 1.0 | 1.0 | 1.0 |
| Amylase | 0.4 | 0.4 | 0.4 |
| Lipase from Stachybotrys | 0.4 | 0.4 | 0.4 |
| chlorohalonata | | | |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.3 | 8.3 | 8.3 |

TABLE 43

| Ingredient | BIO_41 | BIO_42 | BIO_43 |
|---|---|---|---|
| Na soap from palm kernel oil | 2.0 | 2.0 | 2.0 |
| Sodium Citrate | 6.0 | 6.0 | 6.0 |
| MGDA | 1 | 1 | 1 |
| Sodium lauryl ether sulfate | 5 | 5 | 5 |
| (SLES) | | | |
| RAMNOLIPIDS 1 | 15 | — | — |
| RHAMNOLIPIDS 2 | — | 15 | — |
| GLUCOLIPIDS | — | — | 15 |
| Phenoxyethanol | 0.45 | 0.45 | 0.45 |
| Medley ® Brilliant 300 L | 2 | 2 | 2 |
| | Add water | Add water | Add water |
| | to 100% | to 100% | to 100% |
| pH | 8.3 | 8.3 | 8.3 |

TABLE 44

| Ingredient | BIO_44 | BIO_45 | BIO_46 |
|---|---|---|---|
| Na soap from palm kernel oil | 2.0 | 2.0 | 2.0 |
| Sodium Citrate | 6.0 | 6.0 | 6.0 |
| MGDA | 1 | 1 | 1 |
| Alkyl benzene solfonates (LAS) | 3 | 3 | 3 |
| RAMNOLIPIDS 1 | 15 | — | — |
| RHAMNOLIPIDS 2 | — | 15 | — |
| GLUCOLIPIDS | — | — | 15 |
| Phenoxyethanol | 0.45 | 0.45 | 0.45 |
| Medley ® Brilliant 300 L | 2 | 2 | 2 |
| | Add water | Add water | Add water |
| | to 100% | to 100% | to 100% |
| pH | 8.2 | 8.2 | 8.2 |

TABLE 45

| Ingredient | BIO_47 | BIO_48 | BIO_49 |
|---|---|---|---|
| Na soap from palm kernel oil | 2.0 | 2.0 | 2.0 |
| Sodium Citrate | 6.0 | 6.0 | 6.0 |
| MGDA | 1 | 1 | 1 |
| Sodium lauryl ether sulfate | 5 | 5 | 5 |
| (SLES) | | | |
| FAEO | 3 | 3 | 3 |
| RAMNOLIPIDS 1 | 15 | — | — |
| RHAMNOLIPIDS 2 | — | 15 | — |
| GLUCOLIPIDS | — | — | 15 |
| Phenoxyethanol | 0.45 | 0.45 | 0.45 |
| Medley ® Brilliant 300 L | 2 | 2 | 2 |
| | Add water | Add water | Add water |
| | to 100% | to 100% | to 100% |
| pH | 8.3 | 8.3 | 8.3 |

TABLE 46

| Ingredient | BIO_50 | BIO_51 | BIO_52 |
|---|---|---|---|
| Na soap from palm kernel oil | 2 | 2 | 2 |
| Sodium Citrate | 6 | 6 | 6 |
| GLUCOLIPIDS | 15 | 15 | 15 |
| Trilon ® M | 1 | 1 | 1 |
| FAEO (C12-18 7EO) | — | 5 | — |
| Phenoxyethanol | 0.45 | 0.45 | 0.45 |
| NaOH (water solution) | 1.6 | 1.6 | 1.6 |
| Medley ® Brilliant 300 L | 3 | 2 | — |
| | Add water | Add water | Add water |
| | to 100% | to 100% | to 100% |
| pH | 8.3 | 8.3 | 8.4 |

TABLE 47

| Ingredient | BIO_53 | BIO_54 |
|---|---|---|
| Na soap from palm kernel oil | 2 | 2 |
| Sodium Citrate | 6 | 6 |
| GLUCOLIPIDS | 15 | 15 |
| Trilon ® M | 1 | 1 |
| TexCare ® SRN 260 Life | 1 | 2.5 |
| Phenoxyethanol | 0.45 | 0.45 |
| NaOH (water solution) | 1.6 | 1.6 |
| Medley ® Brilliant 300 L | 2 | 2 |
| | Add water | Add water |
| | to 100% | to 100% |
| pH | 8.2 | 8.1 |

TABLE 48

| Ingredient | BIO_55 | BIO_56 | BIO_56A |
|---|---|---|---|
| Na soap from palm kernel oil | 2 | 2 | 2 |
| Sodium Citrate | 6 | 6 | 6 |
| RAMNOLIPIDS 1 | 15 | | 7.5 |
| RHAMNOLIPIDS 2 | — | 15 | 7.5 |
| GLUCOLIPIDS | 5 | 5 | 5 |
| Trilon ® M | 1 | 1 | 1 |
| Carboxy methyl inulin) | 1 | 1 | 1 |
| Carboxyline ®CMI | | | |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 49

| Ingredient | BIO_57 | BIO_58 |
|---|---|---|
| Na soap from palm kernel oil | 2 | 2 |
| Sodium Citrate | 6 | 6 |
| GLUCOLIPIDS | 15 | 15 |
| Trilon ® M | 1 | 1 |
| Carboxy methyl inulin/Carboxyline ®CMI | 2.0 | 2.0 |
| Phenoxyethanol | 0.45 | 0.45 |
| NaOH (water solution) | 1.6 | 1.6 |
| Medley ® Brilliant 300 L | 2 | 2 |
| | Add water | Add water |
| | to 100% | to 100% |
| pH | 8.1 | 8.4 |

TABLE 50

| Ingredient | BIO_59 | BIO_60 |
|---|---|---|
| Na soap from palm kernel oil | 2 | 2 |
| Sodium Citrate | 6 | 6 |
| GLUCOLIPIDS | 15 | 15 |
| Trilon ® M | 1 | 1 |
| Carboxy methyl inulin) Carboxyline ®CMI | | 1 |
| TexCare ® SRN 260 Life | 1 | |
| FAEO (C12-18 7EO) | 5 | 5 |
| Phenoxyethanol | 0.45 | 0.45 |
| NaOH (water solution) | 1.6 | 1.6 |
| Medley ® Brilliant 300 L | 2 | 2 |
| | Add water | Add water |
| | to 100% | to 100% |
| pH | 8.1 | 8.1 |

TABLE 51

| Ingredient | BIO_61 | BIO_62 | BIO_62 |
|---|---|---|---|
| Na soap from palm kernel oil | 2 | 2 | 2 |
| Sodium Citrate | 6 | 6 | 6 |
| RAMNOLIPIDS 1 | 15 | — | — |
| RHAMNOLIPIDS 2 | — | 15 | — |
| GLUCOLIPIDS | — | — | 15 |
| Trilon ® M | 1 | 1 | 1 |
| TexCare ® SRN 170 | 1 | 1 | 1 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 52

| Ingredient | BIO_63 | BIO_64 | BIO_65 |
|---|---|---|---|
| Na soap from palm kernel oil | 2 | 2 | 2 |
| Sodium Citrate | 6 | 6 | 6 |
| RAMNOLIPIDS 1 | 15 | — | — |
| RHAMNOLIPIDS 2 | — | 15 | — |
| GLUCOLIPIDS | — | — | 15 |
| Trilon ® M | 1 | 1 | 1 |
| Dehyton ® PL (lauramine | 1 | 1 | 1 |
| oxide) | | | |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 53

| Ingredient | BIO_66 | BIO_67 | BIO_68 |
|---|---|---|---|
| Na soap from palm kernel oil | 2 | 2 | 2 |
| Sodium Citrate | 6 | 6 | 6 |
| RAMNOLIPIDS 1 | 15 | — | — |
| RHAMNOLIPIDS 2 | — | 15 | — |
| GLUCOLIPIDS | — | — | 15 |
| Trilon ® M | 1 | 1 | 1 |
| REWOFERM SL ONE | 5 | 5 | 5 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

TABLE 54

| Ingredient | BIO_69 | BIO_70 | BIO_71 |
|---|---|---|---|
| Na soap from palm kernel oil | 2 | 2 | 2 |
| Sodium Citrate | 6 | 6 | 6 |
| RAMNOLIPIDS 1 | 15 | — | — |
| RHAMNOLIPIDS 2 | — | 15 | — |
| GLUCOLIPIDS | — | — | 15 |
| Trilon ® M | 1 | 1 | 1 |
| REWOFERM SL P | 5 | 5 | 5 |
| Phenoxyethanol | 0.45 | 0.45 | 0.45 |
| NaOH (water solution) | 1.6 | 1.6 | 1.6 |
| Medley ® Brilliant 300 L | 2 | 2 | 2 |
| | Add water | Add water | Add water |
| | to 100% | to 100% | to 100% |
| pH | 8.1 | 8.4 | 8.4 |

### Laundry Pre-Spotter:

TABLE 51

| | Bio pre- | Bio pre- | Bio pre- |
|---|---|---|---|
| Ingredient | spotter 1 | spotter 2 | spotter 3 |
| Sodium Citrate | 6.0 | 6.0 | 6.0 |
| RAMNOLIPIDS 1 | 10 | — | — |
| RHAMNOLIPIDS 2 | — | 10 | — |
| GLUCOLIPIDS | — | — | 10 |
| Monopropylene glycol | 2 | 2 | 2 |
| Phenoxyethanol | 0.45 | 0.45 | 0.45 |
| Protease | 1.2 | 1.2 | 1.2 |
| Amylase | 0.4 | 0.4 | 0.4 |
| Lipase | 0.4 | 0.4 | 0.4 |
| Pectinase | 0.2 | 0.2 | 0.2 |
| Carenzyme Premium | 0.15 | 0.15 | 0.15 |
| Celluclean 4500T | 0.15 | 0.15 | 0.15 |
| Mannanase | 0.2 | 0.2 | 0.2 |
| | Add water | Add water | Add water |
| | to 100% | to 100% | to 100% |
| pH | 8.0 | 8.0 | 8.0 |

1. A composition, comprising:
A) at least one biosurfactant, and
B) at least one fatty acid salt,
wherein a ratio of component A) to component B) is in a range of 1:1 to 20:1, with the proviso, that component A) and component B) account for at least 90 wt.-% of all surfactants contained in the total composition.

2. The composition according to claim 1, wherein the at least one biosurfactant is selected from the group consisting of rhamnolipids, sophorolipids and glucolipids.

3. The composition according to claim 1, wherein the at least one fatty acid salt is selected from the group consisting of salts of caprylic acid, capric acid, lauric acid, myristic acid, palmitic acid, stearic acid, ricin oleic acid, oleic acid, linoleic acid, elaidic acid, arachidic acid, palmiloteic acid, erucic acid, arachidic acid, linolenic acid and alpha linoleic acid.

4. The composition according to claim 1, wherein a cation of the at least one fatty acid salt is selected from the group consisting of Li⁺, Na⁺, K⁺, Mg²⁺, Ca²⁺, Al³⁺, Zn²⁺, NH₄⁺, primary ammonium ions, secondary ammonium ions, tertiary ammonium ions and quaternary ammonium ions.

5. The composition according to claim 1, further comprising
C) at least one builder.

6. The composition according to claim 1, further comprising
D) at least one enzyme.

7. The composition according to e claim 1, comprising:
A) the at least one biosurfactant in an amount of from 5.0 wt.-% to 60 wt.-%,
B) the at least one fatty acid salt in an amount of from 0.5 wt.-% to 30 wt.-%,
C) optionally, at least one builder in an amount of from 1.0 wt.-% to 30 wt.-%, and
D) optionally, at least one enzyme in an amount of from 0.2 wt.-% to 10 wt.-%,
wherein the percentages by weight refer to the total composition.

8. The composition according to claim 1, which comprises
at least one non-biosurfactant.

9. The composition according to claim 1, comprising:
at least one polymer selected from the group consisting of anti-redeposition polymers and soil release polymers.

10. The composition according to claim 9,
wherein the anti-redeposition polymer or soil release polymer is selected from the group consisting of modified cellulose modified starch, modified inulin, polyitaconic acid, polyvinylpyrrolidone, polyvinyl alcohol, and polyethylene glycol.

11. A process for cleaning a surface of an article, comprising:
a) providing the composition according to claim 1 and an article,
b) combining the composition and the article with water,
c) maintaining a temperature of the water comprising the composition and the article in a temperature range of from 15° C. to 100° C., over a period of time of from 15 minutes to 240 minutes, while optionally moving the article in the water,
d) separating the article from the water, and optionally
e) rinsing the article with further water.

12. A The process according to claim 11,
wherein a weight ratio of the provided article and water in b) and c) are in a range of from 1:2 to 1:20.

13. A The process according to claim 11,
wherein in step b) per kg of water, 0.1 g to 50 g of the composition are provided.

14. A method, comprising:
cleaning a surface of an article in presence of the composition according to claim 1.

15. The method according to claim 14,
wherein the surface of the article is cleaned from fat and/or oil.

16. The composition according to claim 2, wherein the biosurfactant is a rhamnolipid.

17. The composition according to claim 4, wherein in the fatty acid salt cation is Na⁺.

18. The composition according to claim 7, comprising:
the at least one biosurfactant in an amount of from 10.0 wt.-% to 30 wt.-%,
the at least one fatty acid salt in an amount of from 1.5 wt.-% to 10 wt.-%, as may be the case
the at least one builder in an amount of from 3.0 wt.-% to 10 wt.-%, and as may be the case
the at least on enzyme in an amount of from 1.5 wt.-% to 6.0 wt.-%, where the percentages by weight refer to the total composition.

19. The process according to claim 12, wherein the weight ratio of the article and water is in the range of from 1:4 to 1:8.

20. The composition according to claim 6, wherein the at least one enzyme is selected from the group consisting of protease, amylase, lipase, pectinase, cellulase, phosphodiesterase, mannanase, cutinase, pectate lyase, peroxidase, oxidase and laccase.

21. The method according to claim 11, wherein the article is a textile or a fabric.
